(19) United States
(12) Patent Application Publication
(10) Pub. No.: US 2026/0248277 A1
(43) Pub. Date: Aug. 27, 2026

(54) INTEGRATED POWER SUPPLY SYSTEM AND INTEGRATED POWER SUPPLY TABLE

(71) Applicant: Anker Innovations Technology Co., Ltd., CHANGSHA (CN)

(72) Inventors: Wei XIE, SHENZHEN (CN); Yao XIONG, SHENZHEN (CN); Xincan TIAN, SHENZHEN (CN)

(21) Appl. No.: 19/548,592

(22) Filed: Feb. 24, 2026

(30) Foreign Application Priority Data
Feb. 27, 2025 (CN) 202520333153.1
Feb. 27, 2025 (CN) 202520333260.4
Feb. 27, 2025 (CN) 202520338056.1

(51) Int. Cl. A47B 21/06; H01R 13/447; H01R 13/66; H01R 13/72; H01R 25/00

(52) U.S. Cl. CPC A47B 21/06; H01R 13/447; H01R 13/6675; H01R 13/72; H01R 25/006; A47B 2021/066; A47B 2200/0082

(57) ABSTRACT

Embodiments of the present disclosure disclose an integrated power supply system and an integrated power supply table, relating to the technical field of integrated power supply. The integrated power supply system includes a power module, at least one first DC output assembly, and at least one first AC output assembly. The at least one first DC output assembly is electrically connected to the power module; the first DC output assembly includes at least one DC output interface, the DC output interface being configured to provide direct current to a load connected to the first DC output assembly. The at least one first AC output assembly, electrically connected to the power module; the first AC output assembly includes at least one AC output interface, the AC output interface being configured to provide alternating current to another load connected to the first AC output assembly.

### CROSS-REFERENCE TO RELATED APPLICATIONS

The present application claims priority to Chinese Patent Application No. 202520333260.4, titled “Desktop Installation Structure, Integrated Power Supply System and Integrated Power Supply Table”, filed with the China National Intellectual Property Administration on Feb. 27, 2025; Chinese Patent Application No. 202520338056.1, titled “Power Module and Integrated Power Supply System”, filed with the China National Intellectual Property Administration on Feb. 27, 2025; and Chinese Patent Application No. 202520333153.1, titled “Integrated Power Supply System and Integrated Power Supply Table”, filed with the China National Intellectual Property Administration on Feb. 27, 2025, the entire contents of all of which are incorporated herein by reference.

### TECHNICAL FIELD

The present disclosure relates to the technical field of integrated power supply, and particularly to an integrated power supply system and an integrated power supply table.

### BACKGROUND

Office desks often have equipment such as computers, printers, mobile phones, and tablet computers placed on them, each requiring a separate connection to an external power source. In the related art, a power strip may be used as a centralized external power source. However, the plugs of the power strip are directly connected to the mains supply. Therefore, the power cords of the power strip placed on the desk often carry alternating current, which still poses certain safety hazards.

### SUMMARY OF THE DISCLOSURE

In a first aspect, some embodiments of the present disclosure provide an integrated power supply system. The integrated power supply system includes:
a power module;
at least one first direct current (DC) output assembly, electrically connected to the power module; wherein the first DC output assembly comprises at least one DC output interface, the DC output interface being configured to provide direct current to a load connected to the first DC output assembly; and
at least one first alternating current (AC) output assembly, electrically connected to the power module; wherein the first AC output assembly comprises at least one AC output interface, the AC output interface being configured to provide alternating current to another load connected to the first AC output assembly.

In a second aspect, some embodiments of the present disclosure provide an integrated power supply system. The integrated power supply system includes:
a power module; and
at least one power supply assembly, electrically connected to the power module; wherein each power supply assembly comprises at least one direct current (DC) output interface and at least one alternating current (AC) output interface; each DC output interface is configured to provide direct current to a load connected to the power supply assembly, and each AC output interface is configured to provide alternating current to another load connected to the power supply assembly.

In a third aspect, some embodiments of the present disclosure provide an integrated power supply table. The integrated power supply table includes:
a table body;
a power module; and
at least one power supply assembly, electrically connected to the power module; wherein each power supply assembly comprises at least one direct current (DC) output interface and at least one alternating current (AC) output interface; each DC output interface is configured to provide direct current to a load connected to the power supply assembly, and each AC output interface is configured to provide alternating current to another load connected to the power supply assembly.

### BRIEF DESCRIPTION OF THE DRAWINGS

To more clearly illustrate the technical solutions in the embodiments of the present disclosure, the following will provide a brief description of the drawings required in the embodiments. Obviously, the drawings described below are merely some embodiments of the present disclosure. For those skilled in the art, other drawings may be obtained based on these drawings without creative effort.

FIG. 1 is a schematic structural diagram of an integrated power supply table according to some embodiments of the present disclosure.

FIG. 2 is a schematic structural diagram of an integrated power supply table according to other embodiments of the present disclosure.

FIG. 3 is a schematic structural diagram of a table body according to some embodiments of the present disclosure.

FIG. 4 is a schematic structural diagram of an integrated power supply system according to some embodiments of the present disclosure.

FIG. 5 is a schematic block diagram of an integrated power supply system according to some embodiments of the present disclosure.

FIG. 6 is a schematic structural diagram of a first power supply assembly according to some embodiments of the present disclosure.

FIG. 7 is an exploded structural diagram of a first power supply assembly according to some embodiments of the present disclosure.

FIG. 8 is a schematic structural diagram of a first DC output assembly according to some embodiments of the present disclosure.

FIG. 9 is a schematic structural diagram of a first DC output assembly according to other embodiments of the present disclosure.

FIG. 10 is a schematic structural diagram of a first AC output assembly according to some embodiments of the present disclosure.

FIG. 11 is a schematic structural diagram of a first AC output assembly according to other embodiments of the present disclosure.

FIG. 12 is a schematic block diagram of an integrated power supply system according to other embodiments of the present disclosure.

FIG. 13 is a schematic block diagram of an integrated power supply system according to further other embodiments of the present disclosure.

FIG. 14 is a schematic block diagram of an integrated power supply system according to still other embodiments of the present disclosure.

FIG. 15 is a schematic structural diagram of a desktop installation structure according to some embodiments of the present disclosure.

FIG. 16 is a schematic structural diagram of a desktop installation structure according to other embodiments of the present disclosure.

FIG. 17 is a schematic structural diagram of a retractable cable assembly according to some embodiments of the present disclosure.

FIG. 18 is a schematic structural diagram of a retractable cable assembly according to other embodiments of the present disclosure.

FIG. 19 is a schematic structural diagram of a power module according to some embodiments of the present disclosure.

FIG. 20 is a schematic block diagram of an integrated power supply system according to yet other embodiments of the present disclosure.

FIG. 21 is an exploded structural diagram of a power module according to some embodiments of the present disclosure.

FIG. 22 is an exploded structural diagram of a power module according to other embodiments of the present disclosure.

FIG. 23 is an enlarged view of portion A circumscribed in FIG. 21.

FIG. 24 is an enlarged view of portion B circumscribed in FIG. 21.

### DETAILED DESCRIPTION

The following will clearly and completely describe the technical solutions in the embodiments of the present disclosure with reference to the accompanying drawings. Obviously, the described embodiments are only a part of the embodiments of the present disclosure, not all of them. Based on the embodiments of the present disclosure, all other embodiments obtained by those skilled in the art without creative effort shall fall within the scope of the present disclosure.

It should be noted that all directional indicators (such as up, down, left, right, front, back, etc.) in the embodiments of the present disclosure are only intended to explain the relative positional relationships, movement states, etc., between various components under a specific posture (as shown in the drawings). When the specific posture changes, the directional indicators will change accordingly.

Furthermore, the descriptions of “first”, “second”, etc., in the present disclosure are for descriptive purposes only and cannot be understood as indicating or implying relative importance or implicitly specifying the quantity of the indicated technical features. Thus, features defined with “first” and “second” may explicitly or implicitly include at least one of the features. In the description of the present disclosure, “multiple” means at least two, such as two, three, etc., unless otherwise explicitly and specifically defined.

In the present disclosure, unless otherwise explicitly specified and defined, the terms “connect”, “fix”, etc., should be understood broadly. For example, “fixing” may be a fixed connection, a detachable connection, or integrated into one piece; it may be a mechanical connection, an electrical connection, or direct connection, or indirect connection through an intermediate medium, or internal communication between two elements or the interaction relationship between two elements, unless otherwise explicitly defined. Those of ordinary skill in the art can understand the specific meanings of the above terms in the present disclosure based on specific situations.

In addition, the technical solutions between the various embodiments of the present disclosure may be combined with each other, but it must be based on the premise that those skilled in the art can achieve it. When the combination of technical solutions is contradictory or impossible to achieve, it should be considered that such a combination of technical solutions does not exist and is not within the scope of protection claimed by the present disclosure.

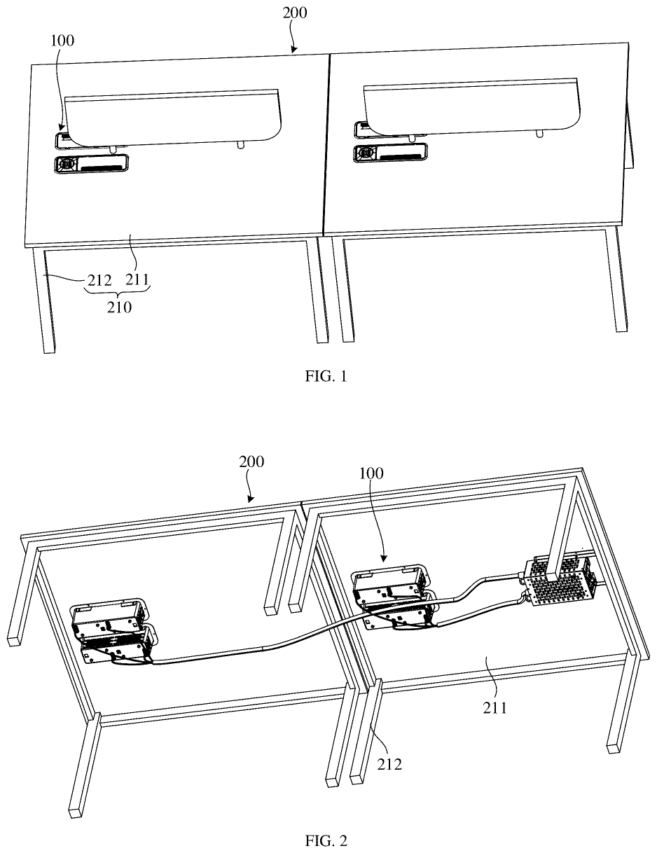

As shown in FIGS. 1-3, a first aspect of the embodiments of the present disclosure provides an integrated power supply table 200. The integrated power supply table 200 includes an integrated power supply system 100 and a table body 210. The table body 210 includes a tabletop 211 and multiple table legs 212 supporting the tabletop 211. Several main modules included in the integrated power supply system 100 are respectively arranged on the table body 210 (which will be described in detail below). The integrated power supply system 100 can receive mains power input and provide at least one of alternating current and direct current through its output interfaces located on the tabletop, thereby meeting the usage needs of different users.

As shown in FIG. 4, a second aspect of the embodiments of the present disclosure provides an integrated power supply system 100. The integrated power supply system 100 includes a power module 110 and at least one power supply module 120 connected to the power module 110. The power module 110 is configured to convert mains electricity into direct current, and the power supply module 120 is configured to output alternating current and/or direct current according to the needs of the connected load.

As shown in FIG. 5, the power module 110 includes a first rectification module 1111. The first rectification module 1111 can rectify alternating current into direct current. For example, the first rectification module 1111 receives external mains input via a cable and outputs direct current. The input voltage of the first rectification module 1111 may exemplarily be 110V-230V. The input frequency of the first rectification module 1111 may exemplarily be 40 Hz, 50 Hz, or 60 Hz. In terms of rectification form, the rectification method of the first rectification module 1111 may be full-wave rectification or half-wave rectification. Exemplarily, the first rectification module 1111 may rectify 220V, 50 Hz alternating current into 20V direct current.

Exemplarily, the power module 110 is arranged under the tabletop 211 of the table body 210 that carries the power module 110, thereby saving space on the tabletop 211 and avoiding the presence of wiring lines transmitting alternating current on the tabletop frequently contacted by users, which may improve the safety of power supply.

In the embodiments, the power supply module 120 includes a power supply assembly. The power supply assembly is configured to supply power to the load. The power supply assembly can output direct current and/or alternating current. Exemplarily, the power supply assembly includes at least one DC output interface and at least one AC output interface. The DC output interface is configured to provide direct current to the load connected to the power supply assembly. The AC output interface is configured to provide alternating current to the load connected to the power supply assembly.

In some embodiments, at least two sets of power supply assemblies are provided. The at least two sets of power supply assemblies share one power module to simplify the structure of the integrated power supply system, thereby reducing the volume occupied by the integrated power supply system on the table body. In other embodiments, each set of power supply assemblies may be configured with one corresponding power module, meaning that the power supply assemblies correspond one-to-one with the power modules.

In some embodiments, part of the structure of the power supply assembly is arranged in an area below the tabletop of the table body, and at least one DC output interface or at least one AC output interface is exposed on the tabletop, thereby not only reducing the space occupied by the power supply assembly on the tabletop but also facilitating user use. In other embodiments, the power supply assembly may be entirely located in an area above the tabletop, or entirely in the area below the tabletop.

In some embodiments, as shown in FIG. 4, at least two sets of power supply assemblies are arranged side by side along a first direction XX to expand the number of output interfaces of the integrated power supply system for use by more loads. In other embodiments, only one power supply assembly may be arranged in the first direction XX, with the specific number determined according to user needs.

In some embodiments, as shown in FIG. 4, at least two sets of power supply assemblies are arranged at intervals along a second direction YY, where the first direction is perpendicular to the second direction. The at least two sets of power supply assemblies arranged at intervals along the second direction YY may be arranged on a same table body or on different table bodies. Arranging them at intervals along the second direction YY can provide heat dissipation space between the different power supply assemblies while enabling users to utilize a nearest power supply assembly based on the location of the load being used.

Exemplarily, the second direction may be a left-right direction of the table body, and the first direction may be a front-back direction of the table body. The left-right direction mentioned here may be understood as the length direction of the table body, and the front-back direction may be understood as the width direction of the table body. The width direction of the table body is usually parallel to a direction facing the table body when the user uses the table body.

It is worth mentioning that the structures of the various sets of power supply assemblies are basically the same. For convenience of description, a first power supply assembly, a second power supply assembly, a third power supply assembly, a fourth power supply assembly, etc., are intended for specific explanation.

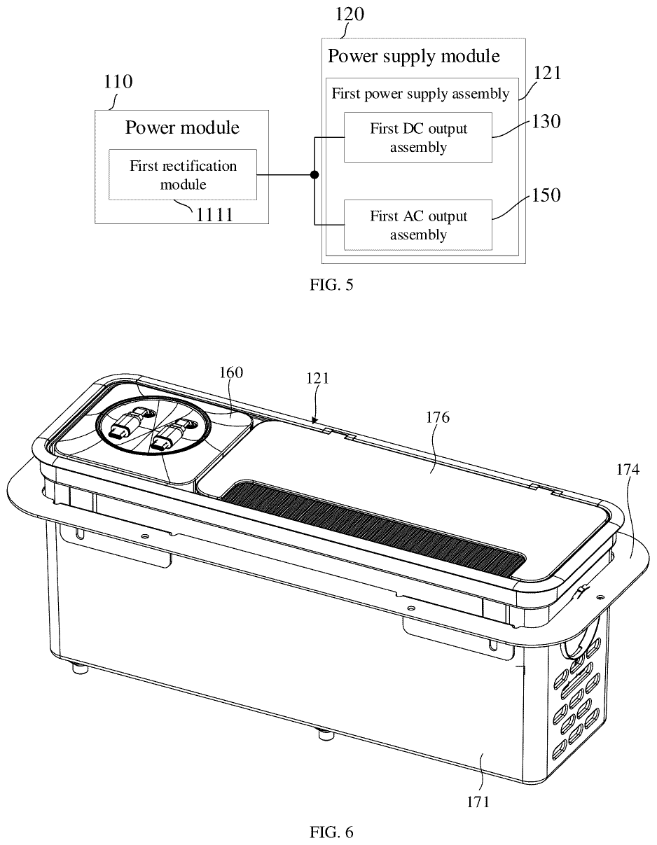

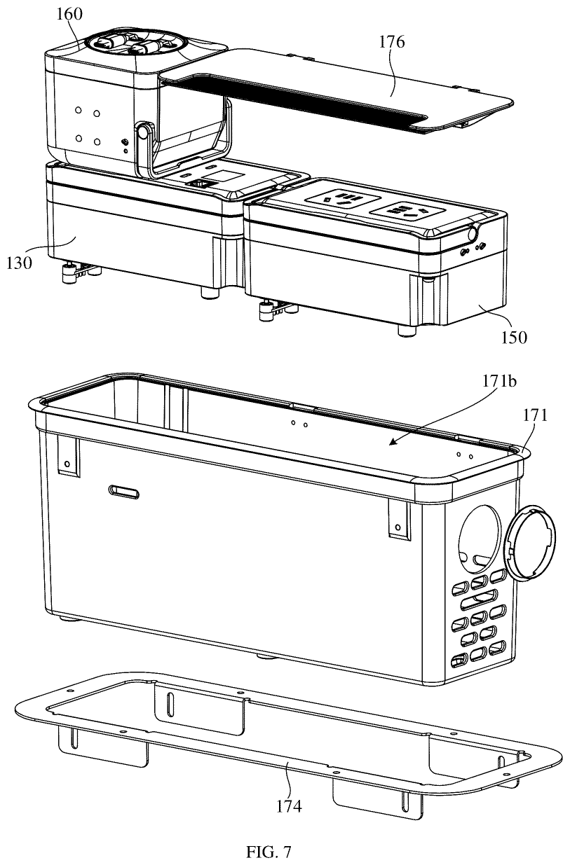

As shown in FIG. 5, the power supply module 120 includes a first power supply assembly 121. The first power supply assembly 121 is configured to supply power to the load. The first power supply assembly 121 can output direct current and/or alternating current. Exemplarily, as shown in FIGS. 6-7, the first power supply assembly 121 may include a first DC output assembly 130 and a first AC output assembly 150. Exemplarily, the first power supply assembly 121 includes at least one DC output interface and at least one AC output interface. The DC output interface is configured to provide direct current to the load connected to the power supply assembly. The AC output interface is configured to provide alternating current to the load connected to the power supply assembly.

In some embodiments, part of the structure of the first power supply assembly 121 is arranged in an area below the tabletop 211 of the table body 210, and the at least one DC output interface or the at least one AC output interface is exposed on the tabletop 211, thereby not only reducing the space occupied by the first power supply assembly on the tabletop but also facilitating user use.

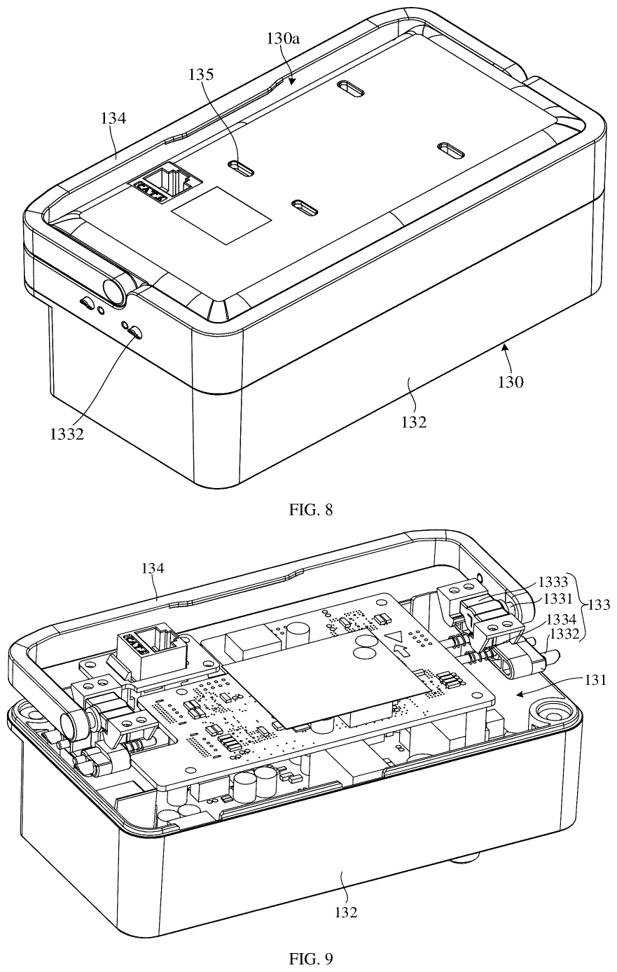

As shown in FIGS. 8-9, the first DC output assembly 130 includes a first DC voltage conversion module 131 electrically connected to the first rectification module 1111, and at least one DC output interface 135 electrically connected to the first DC voltage conversion module 131. The first DC voltage conversion module 131 is configured to receive the direct current output by the first rectification module 1111 and provide direct current to the load connected to the first DC output assembly 130 through the at least one DC output interface 135. The first DC voltage conversion module 131 can transform the voltage of the direct current to adapt to different electronic devices. For example, the first DC voltage conversion module 131 can step down 20V direct current to 5V, or step up 20V direct current to 36V. Of course, when the direct current voltage output by the first rectification module 1111 is the voltage required by the user, the first DC voltage conversion module 131 can directly output the original voltage direct current without voltage conversion processing.

As shown in FIG. 8, exemplarily, the type of the DC output interface 135 may be a USB Type-C interface, specifically a USB Type-C female port. The USB Type-C interface is gradually becoming mainstream, compatible with a variety of devices, does not require distinguishing positive and negative sides, and is relatively convenient to use. In other embodiments, the type of the DC output interface 135 may be a USB interface, a lightning interface, or other DC output interfaces, which is not limited herein.

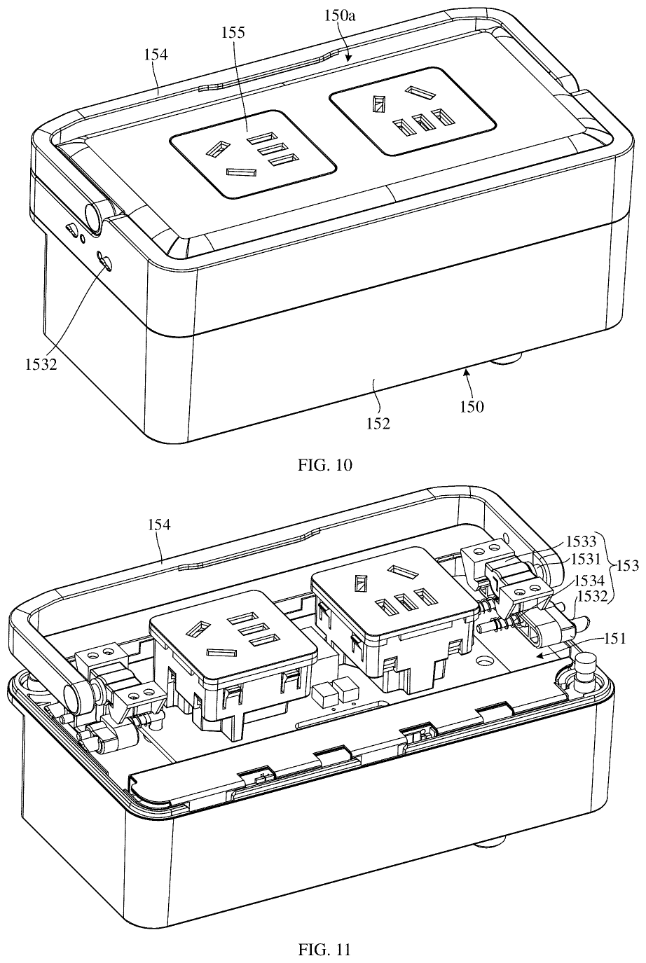

As shown in FIGS. 10-11, the first AC output assembly 150 includes a first inverter module 151 electrically connected to the first rectification module 1111, and at least one AC output interface 155 electrically connected to the first inverter module 151. The first inverter module 151 is configured to receive the direct current output by the first rectification module 1111 and provide alternating current to the load connected to the first AC output assembly 150 through the at least one AC output interface 155. The first inverter module 151 can invert direct current into alternating current. For example, the first inverter module 151 can invert 20V direct current into alternating current with a voltage range of 110V to 230V, and a frequency of 40 Hz, 50 Hz, or 60 Hz.

As shown in FIG. 10, exemplarily, the type of the AC output interface 155 may be a two-hole socket, a three-hole socket, or a socket having both two-hole and three-hole sockets. The two-hole socket has a simple design and is easy to plug and unplug, suitable for daily use. The three-hole socket has a ground wire and offers better safety. The standard type of the socket may be Chinese standard, American standard, European standard, Japanese standard, etc.

Exemplarily, the first DC output assembly 130 is detachably connected to the table body 210 that carries the first DC output assembly 130, and the first AC output assembly 150 is detachably connected to the table body 210 that carries the first AC output assembly 150. The first DC output assembly 130 and the first AC output assembly 150 are independently arranged on the tabletop 211. That is, the first DC output assembly 130 can be independently installed on the tabletop 211 or detached from the tabletop 211, and the first AC output assembly 150 can be independently installed on the tabletop 211 or detached from the tabletop 211. The installation or detachment of the first DC output assembly 130 and the first AC output assembly 150 does not affect each other.

It is understandable that devices such as computers and printers need to be connected to alternating current, while electronic products such as mobile phones and tablet computers need to be connected to direct current. Different users have different needs for AC and DC. Therefore, users can choose to install only the first DC voltage conversion module 131, or only the first inverter module 151, or install both the first DC voltage conversion module 131 and the first inverter module 151 simultaneously, thereby offering relatively flexible choices.

In the embodiments, since the power module 110 first converts alternating current into direct current, then the first DC output assembly 130 transforms the voltage of the direct current, and the first AC output assembly 150 inverts the direct current into alternating current, the wiring lines between the power module 110 and the first DC output assembly 130 transmit direct current, and the wiring lines between the power module 110 and the first AC output assembly 150 also transmit direct current. This avoids users contacting the wiring transmission of alternating current while working on the tabletop 211, thereby improving electrical safety. In addition, it enables receiving both DC interface output and AC interface output on the tabletop 211 through one power module 110, enhancing the convenience of power usage.

Furthermore, the power module 110 usually has a certain ability to suppress grid interference. The power module 110 often enables the voltage and current of the output direct current to be stable within a preset range, outputting relatively stable direct current. Moreover, the first AC output assembly 150 can control and adjust the frequency and voltage of the alternating current relatively precisely. Therefore, even if the mains voltage has certain fluctuations, through the coordinated cooperation of the power module 110 and the first AC output assembly 150, the alternating current output by the first AC output assembly 150 may be relatively stable, thereby improving the stability and reliability of the power supply.

In other embodiments, the first rectification module 1111 may be integrated into the power supply module 120, for example, integrated into the first DC output assembly 130 or the first AC output assembly 150.

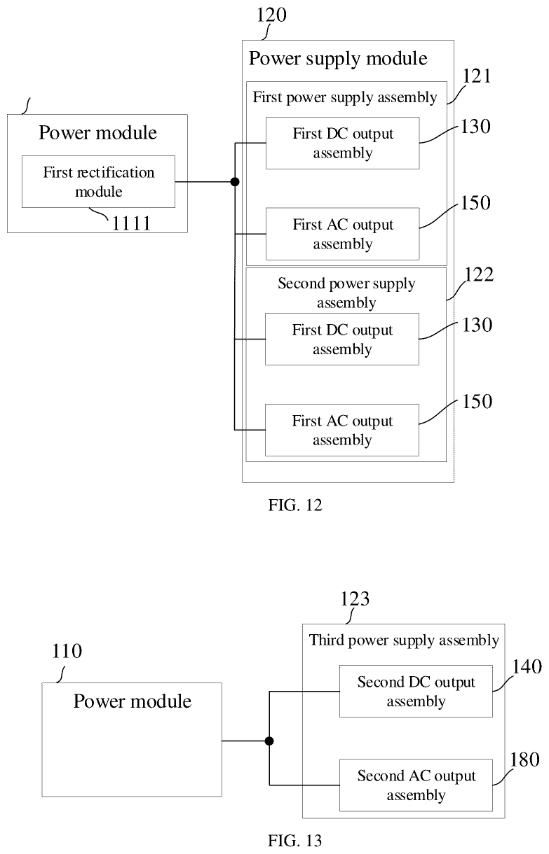

As shown in FIGS. 4 and 12, in some embodiments, the power supply module 120 further includes a second power supply assembly 122. The second power supply assembly 122 is configured to supply power to the load. The second power supply assembly 122 can output direct current and/or alternating current. Exemplarily, the second power supply assembly 122 includes another first DC output assembly 130 and another first AC output assembly 150. The power module 110 is electrically connected to both the two first DC output assemblies 130 and the two first AC output assemblies 150. That is, the power supply module 120 includes at least one first DC output assembly 130 and at least one first AC output assembly 150.

As shown in FIGS. 4 and 13, in some embodiments, the power supply module 120 may further include a third power supply assembly 123. The third power supply assembly 123 is configured to supply power to the load. The third power supply assembly 123 can output direct current and/or alternating current. Exemplarily, the third power supply assembly 123 may include a second DC output assembly 140 and a second AC output assembly 180.

The second DC output assembly 140 includes a second DC voltage conversion module electrically connected to the first rectification module 1111, and at least one DC output interface electrically connected to the second DC voltage conversion module. The second DC voltage conversion module is configured to receive the direct current output by the first rectification module 1111 and provide direct current to the load connected to the second DC output assembly 140 through the at least one DC output interface. The second DC voltage conversion module can transform the voltage of the direct current to adapt to different electronic devices. For example, the second DC voltage conversion module can step down 20V direct current to 5V, or step up 20V direct current to 36V. Of course, when the direct current voltage output by the first rectification module 1111 is the voltage required by the user, the second DC voltage conversion module can directly output the original voltage direct current without voltage conversion processing.

Exemplarily, the structure of the second DC output assembly 140 is the same as that of the first DC output assembly 130, and the circuit configuration of the second DC output assembly 140 is the same as that of the first DC output assembly 130. That is, the structure and internal circuit configuration of the second DC output assembly 140 are completely identical to those of the first DC output assembly 130. The second DC output assembly 140 and the first DC output assembly 130 can be used interchangeably.

Exemplarily, the second DC output assembly 140 is detachably connected to the table body 210 or another table body 210 that carries the second DC output assembly 140. That is, the second DC output assembly 140 and the first DC output assembly 130 may be arranged on a same table body 210 or on different table bodies 210.

The second AC output assembly 180 includes a second inverter module electrically connected to the first rectification module 1111, and at least one AC output interface electrically connected to the second inverter module. The second inverter module is configured to receive the direct current output by the first rectification module 1111 and provide alternating current to the load connected to the second AC output assembly 180 through the at least one AC output interface. The second inverter module can invert direct current into alternating current. For example, the second inverter module can invert 20V direct current into alternating current with a voltage range of 110V to 230V, and a frequency of 40 Hz, 50 Hz, or 60 Hz.

Exemplarily, the structure of the second AC output assembly 180 is the same as that of the first AC output assembly 150, and the circuit configuration of the second AC output assembly 180 is the same as that of the first AC output assembly 150. That is, the structure and internal circuit configuration of the second AC output assembly 180 are completely identical to those of the first AC output assembly 150. The second AC output assembly 180 and the first AC output assembly 150 can be used interchangeably.

Exemplarily, the second AC output assembly 180 is detachably connected to the table body 210 or another table body 210 that carries it. That is, the second AC output assembly 180 and the first AC output assembly 150 may be arranged on a same table body 210 or on different table bodies 210.

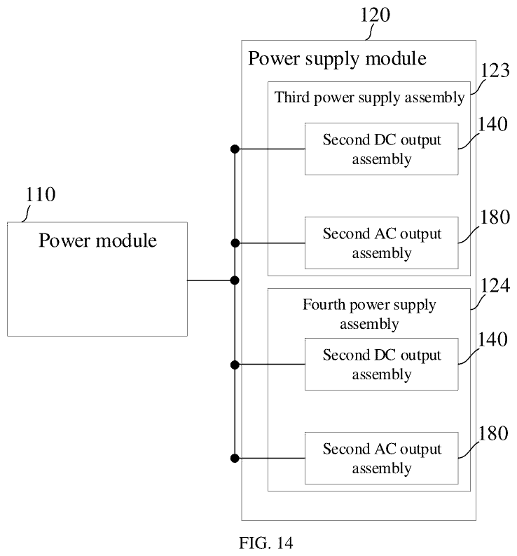

As shown in FIGS. 4 and 14, in some embodiments, the power supply module 120 may further include a fourth power supply assembly 124. The fourth power supply assembly 124 is configured to supply power to the load. The fourth power supply assembly 124 can output direct current and/or alternating current. Exemplarily, the fourth power supply assembly 124 may include another second DC output assembly 140 and another second AC output assembly 180. The power module 110 is electrically connected to both the two second DC output assemblies 140 and the two second AC output assemblies 180. That is, the power supply module 120 includes at least one second DC output assembly 140 and at least one second AC output assembly 180.

In some embodiments, as shown in FIGS. 2 and 4, a part of the components in the integrated power supply system 100 are arranged on a back side of the tabletop 211, thereby reducing the occupation of the front side space of the tabletop 211, resulting in a larger usable area of the tabletop 211, a more aesthetically pleasing tabletop 211, and less likelihood of collision with external objects on the tabletop 211, thus offering better safety. Exemplarily, the power module 110 is arranged on the back side of the tabletop 211. The tabletop 211 defines an accommodating groove 211a. The first power supply assembly 121, the second power supply assembly 122, the third power supply assembly 123, and the fourth power supply assembly 124 are all arranged on a front side of the tabletop 211 and pass through the accommodating groove 211a on the tabletop 211.

Exemplarily, the integrated power supply system 100 is detachably connected to the table body 210, facilitating the installation and maintenance of the integrated power supply system 100 and allowing the integrated power supply system 100 to be combined with different table bodies 210. For example, the integrated power supply system 100 is connected to the table body 210 by screwing, snapping, etc. Exemplarily, the power module 110, the first power supply assembly 121, the second power supply assembly 122, the third power supply assembly 123, and the fourth power supply assembly 124 are all detachably connected to the table body 210 respectively.

Exemplarily, the integrated power supply system 100 is fixedly connected to the table body 210, making the integrated power supply system 100 relatively stable and less likely to fall. For example, the integrated power supply system 100 is connected to the table body 210 by screwing, adhesive bonding, etc. Exemplarily, the power module 110, the first power supply assembly 121, the second power supply assembly 122, the third power supply assembly 123, and the fourth power supply assembly 124 are all fixedly connected to the table body 210 respectively. It should be noted that detachable connection is relative to non-detachable connection, and fixed connection is relative to movable connection.

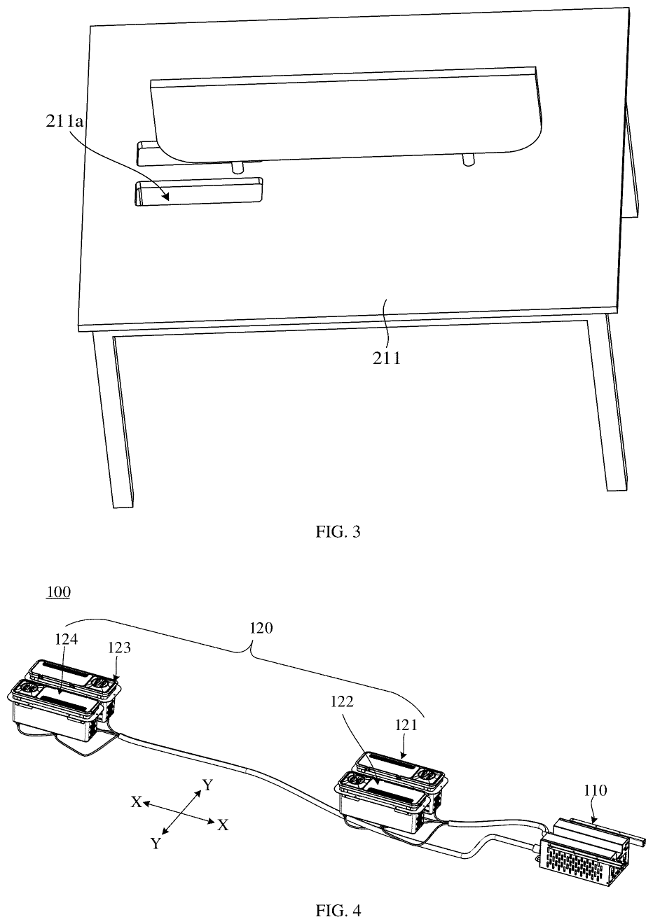

As shown in FIGS. 3, 4, and 7, in some embodiments, the tabletop 211 defines an accommodating groove 211a, for example, a groove defined by inward concavity of the tabletop 211. The first DC output assembly 130 and the first AC output assembly 150 may both be arranged in the accommodating groove 211a, thereby reducing the space occupied by the first DC output assembly 130 and the first AC output assembly 150, helping to keep the tabletop 211 tidy. The shape of the accommodating groove 211a may be rectangular, circular, etc., which is not limited herein. Exemplarily, the accommodating groove 211a is a through groove, allowing the first DC output assembly 130 and the first AC output assembly 150 to partially pass through the accommodating groove 211a, thereby making full use of the space below the tabletop 211. In this case, the first DC output assembly 130 and the first AC output assembly 150 are required to be directly or indirectly fixedly connected to the tabletop 211 to prevent them from falling out of the through groove.

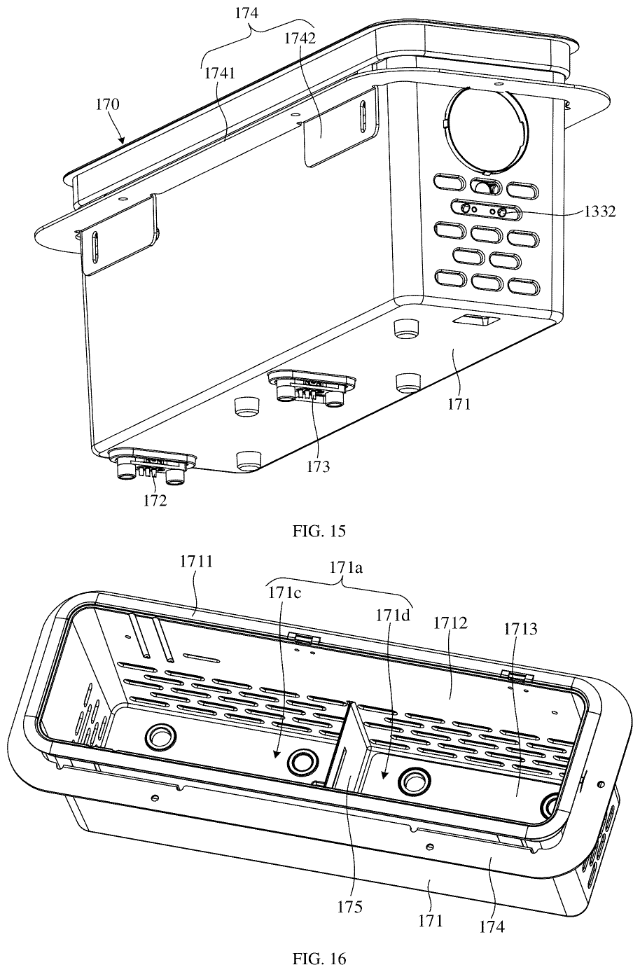

As shown in FIG. 15, in some embodiments, the integrated power supply system 100 further includes a desktop installation structure 170. The desktop installation structure 170 is configured to accommodate the first DC output assembly 130 and the first AC output assembly 150.

In other embodiments, the number of desktop installation structures 170 is two. The first power supply assembly 121 is arranged in one of the desktop installation structures 170, and the second power supply assembly 122 is arranged in the other desktop installation structure 170.

Furthermore, in other embodiments, the number of desktop installation structures 170 is four. The third power supply assembly 123 is arranged in one of the desktop installation structures 170, and the fourth power supply assembly 124 is arranged in another desktop installation structure 170.

As shown in FIG. 15, a third aspect of the embodiments of the present disclosure provides a desktop installation structure 170. The desktop installation structure 170 includes an installation frame 171. The installation frame 171 is configured to be installed on the tabletop 211 of the table body 210, and its interior is configured to accommodate the placed first DC output assembly 130 and first AC output assembly 150.

Exemplarily, as shown in FIG. 7, both the first DC output assembly 130 and the first AC output assembly 150 are arranged within the installation frame 171. The installation frame 171 can provide stable support for the first DC output assembly 130 and the first AC output assembly 150 and protect them, thereby improving the safety of the first DC output assembly 130 and the first AC output assembly 150.

Exemplarily, the material of the installation frame 171 is plastic, thus being lightweight, low cost, easy to process, able to be injection molded into various complex shapes, and able to provide insulation. Exemplarily, the material of the installation frame 171 is metal, thereby having good heat dissipation performance, able to assist the first DC output assembly 130 and the first AC output assembly 150 in heat dissipation, and having high strength and good load-bearing performance. Exemplarily, the installation frame 171 defines multiple heat dissipation holes, which is beneficial for the heat dissipation of the first DC output assembly 130 and the first AC output assembly 150.

In some embodiments, the installation frame 171 is fixedly connected to the tabletop 211. Compared to placing the installation frame 171 on the tabletop 211, fixedly connecting the installation frame 171 to the tabletop 211 is more stable, less prone to tipping or slipping, and may improve the safety and stability of the first DC output assembly 130 and the first AC output assembly 150. After the installation frame 171 is fixed on the tabletop 211, the positions of the first DC output assembly 130 and the first AC output assembly 150 are relatively fixed. By optimizing the installation position when installing the installation frame 171, the distance between the installation frame 171 and the workstation may be made more appropriate, making it more convenient to use. Exemplarily, the fixing method between the installation frame 171 and the tabletop 211 may be screw fixing, snap fixing, or adhesive fixing.

In some embodiments, the installation frame 171 is detachably connected to the tabletop 211, allowing the installation frame 171 to be easily removed when cleaning, maintenance, or replacement is needed, thus facilitating cleaning, maintenance, assembly, etc. Moreover, users can detach the installation frame 171 from the tabletop 211 and reinstall it in other positions according to actual needs or changes in spatial layout, thereby meeting the needs of different scenarios. The detachable connection between the installation frame 171 and the tabletop 211 further helps save space. When the installation frame 171 is not needed, it can be detached and stored, thereby avoiding occupying space of the tabletop 211, making the tabletop 211 more spacious and facilitating other activities. Exemplarily, the connection method between the installation frame 171 and the tabletop 211 may be screw connection, magnetic connection, bayonet connection, etc.

In some embodiments, the installation frame 171 may be arranged in the accommodating groove 211a. That is, the first DC output assembly 130 and the first AC output assembly 150 are arranged in the accommodating groove 211a spaced apart by the installation frame 171. Exemplarily, the size of the installation frame 171 is adapted to the size of the accommodating groove 211a, such that the gap between the installation frame 171 and the accommodating groove 211a is small, the installation frame 171 can make full use of the space of the accommodating groove 211a, and the space utilization rate of the installation frame 171 is high.

Exemplarily, the accommodating groove 211a is a blind groove, and a bottom wall of the accommodating groove 211a can support the installation frame 171.

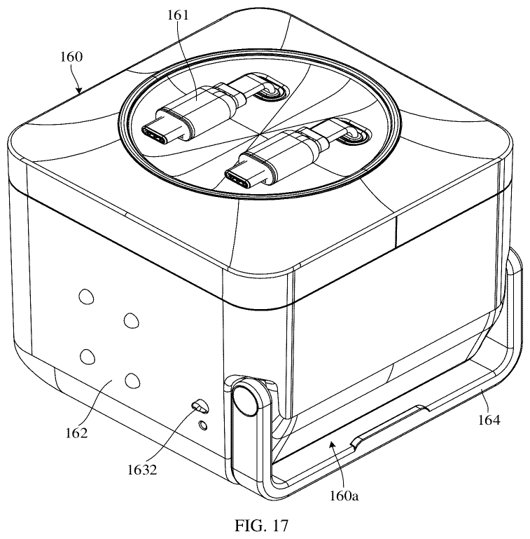

Exemplarily, as shown in FIG. 16, the accommodating groove 211a is a through groove. A top of the installation frame 171 is arranged with a flange 1711. The flange 1711 abuts against a front side of the tabletop 211, thereby preventing the installation frame 171 from falling out of the accommodating groove 211a. Exemplarily, the installation frame 171 extends beyond a lower opening of the accommodating groove 211a, making full use of the space below the tabletop 211.

In other embodiments, the installation frame 171 may be arranged on the front side or the back side of the tabletop 211, which is not limited herein.

As shown in FIG. 16, in some embodiments, the installation frame 171 includes a bottom wall 1713, multiple side walls 1712, an installation cavity 171a defined by the enclosure of the bottom wall 1713 and the multiple side walls 1712, and an opening 171b communicated with a top of the installation cavity 171a. The installation cavity 171a includes a first installation cavity 171c configured to install an external first DC output assembly 130, and a second installation cavity 171d configured to install an external first AC output assembly 150, thereby allowing the first DC output assembly 130 and the first AC output assembly 150 to be relatively isolated, so as to avoid mutual influence.

As shown in FIG. 7, in some embodiments, the desktop installation structure 170 further includes a brush cover plate 176. The brush cover plate 176 can cover the opening 171b, preventing dust and other foreign matter from falling into the installation cavity 171a, and keeping the interior of the installation cavity 171a as clean as possible. Wires can pass through the brush part of the brush cover plate 176, thus not affecting the user's use of the first DC output assembly 130 and the first AC output assembly 150.

As shown in FIG. 7, in some embodiments, the first DC output assembly 130, the first AC output assembly 150, and a retractable cable assembly 160 are all installed in the installation frame 171. At least one of the first DC output assembly 130, the first AC output assembly 150, and the retractable cable assembly 160 is detachably connected to the installation frame 171, facilitating installation or detachment.

As shown in FIG. 7, in some embodiments, the retractable cable assembly 160 covers a part of a top area of the first DC output assembly 130, making the arrangement of the retractable cable assembly 160 and the first DC output assembly 130 relatively compact, thereby saving space. A top of the first DC output assembly 130 is arranged with a DC output interface exposed outside the retractable cable assembly 160 to ensure that the DC output interface is not blocked, facilitating user use. The first DC output assembly 130 and the first AC output assembly 150 are arranged side by side to make the structure compact. The retractable cable assembly 160 is arranged above the first DC output assembly 130 to facilitate user use of the data cable. The brush cover plate 176 is arranged side by side with a top of the retractable cable assembly 160, and the brush cover plate 176 is spaced apart from the first AC output assembly 150 to reserve space for accommodating plugs.

As shown in FIG. 16, in some embodiments, the interior of the installation frame 171 is arranged with a partition plate 175. The partition plate 175 divides the installation frame 171 into the first installation cavity 171c and the second installation cavity 171d. The partition plate 175 is configured to guide the first DC output assembly 130 into the first installation cavity 171c or the second installation cavity 171d, and to guide the first AC output assembly 150 into the second installation cavity 171d or the first installation cavity 171c. Exemplarily, a top height of the partition plate 175 is lower than a top height of the installation frame 171. That is, the opening 171b of the installation frame 171 is relatively large, making it easier for the first DC output assembly 130 (or the first AC output assembly 150) to partially extend into the installation frame 171. Then, by sliding the first DC output assembly 130 (or the first AC output assembly 150) along the side wall 1712, it can automatically align with the first installation cavity 171c or the second installation cavity 171d, thus requiring lower alignment accuracy from the user. Exemplarily, the first DC output assembly 130 and the first AC output assembly 150 are installed in the first installation cavity 171c and the second installation cavity 171d respectively.

Furthermore, the partition plate 175 may play a limiting role for the first DC output assembly 130 and the first AC output assembly 150, reducing their shaking. In addition, the partition plate 175 can connect the two opposite inner walls of the installation frame 171, thereby improving the structural strength of the installation frame 171.

As shown in FIGS. 15 and 16, in some embodiments, the desktop installation structure 170 further includes an installation member 174. The installation member 174 is fixedly connected to both the table body 210 and the installation frame 171 to fix the installation frame 171 to the tabletop 211. By providing the installation member 174, it may prevent the installation frame 171 from falling off the tabletop 211. Exemplarily, the installation member 174 may be fixedly connected to the back side of the tabletop 211 and the side wall of the installation frame 171 respectively.

Exemplarily, the installation member 174 may be detachably connected to the tabletop 211 and the installation frame 171. For example, the connection method between the installation member 174 and the tabletop 211 may be screwing, snapping, hook-and-loop fastening, etc.

As shown in FIGS. 15 and 16, the installation member 174 includes a first connection plate 1741 parallel to the tabletop 211 and multiple second connection plates 1742 respectively parallel to the side walls 1712. The first connection plate 1741 is fixedly connected to the multiple second connection plates 1742. The first connection plate 1741 is configured to be fixedly connected to the tabletop 211. The multiple second connection plates 1742 are respectively configured to be fixedly connected to the corresponding side walls 1712.

As shown in FIG. 15, in some embodiments, the desktop installation structure 170 further includes a first electrical connection terminal 172. The first electrical connection terminal 172 is arranged on the installation frame 171. The first electrical connection terminal 172 is configured to connect to an external power module 110 to receive power input. For example, the first DC voltage conversion module 131 is electrically connected to an end of the first electrical connection terminal 172, and another end of the first electrical connection terminal 172 is electrically connected to the first rectification module 1111. That is, the first electrical connection terminal 172 can enable the electrical connection between the first rectification module 1111 and the first DC voltage conversion module 131. Since the first electrical connection terminal 172 can be easily plugged and unplugged, it is more convenient during installation, and the installation difficulty is lower. Exemplarily, the first DC voltage conversion module 131 is arranged with a first plug terminal adapted to the first electrical connection terminal 172. The first DC voltage conversion module 131 and the first electrical connection terminal 172 can be directly plugged together. Alternatively, a first plug terminal with a wire may be arranged between the first DC voltage conversion module 131 and the first electrical connection terminal 172 to plug with the first electrical connection terminal 172, making the installation position of the first DC voltage conversion module 131 within the first housing 132 more flexible.

As shown in FIG. 15, in some embodiments, the first electrical connection terminal 172 is arranged on a bottom wall of the installation frame 171 and located in the first installation cavity 171c, thereby making full use of the space in the height direction of the installation frame 171. Exemplarily, the first electrical connection terminal 172 is arranged in the first installation cavity 171c. When the first DC output assembly 130 is installed in the first installation cavity 171c, the first DC output assembly 130 is electrically connected to the first electrical connection terminal 172. The direction of the first electrical connection terminal 172 relative to the first DC output assembly 130 is opposite to the direction in which the first DC output assembly 130 is placed into the first installation cavity 171c, such that when the first DC output assembly 130 is placed into the first installation cavity 171c, it can simultaneously plug and connect with the first electrical connection terminal 172, thereby facilitating assembly.

As shown in FIG. 15, in some embodiments, the desktop installation structure 170 further includes a second electrical connection terminal 173. The second electrical connection terminal 173 is arranged on the installation frame 171. The second electrical connection terminal 173 is configured to connect to an external power module 110 to receive power input. For example, the first inverter module 151 is electrically connected to an end of the second electrical connection terminal 173, and another end of the second electrical connection terminal 173 is electrically connected to the first rectification module 1111. That is, the second electrical connection terminal 173 can enable the electrical connection between the first rectification module 1111 and the first inverter module 151. Since the second electrical connection terminal 173 can be easily plugged and unplugged, it is more convenient during installation, and the installation difficulty is lower. Exemplarily, the first inverter module 151 is arranged with a second plug terminal adapted to the second electrical connection terminal 173. The first inverter module 151 and the second electrical connection terminal 173 are directly plugged together. Alternatively, a second plug terminal with a wire may be arranged between the first inverter module 151 and the second electrical connection terminal 173 to plug with the second electrical connection terminal 173, making the installation position of the first inverter module 151 within the second housing 152 more flexible.

As shown in FIG. 15, in some embodiments, the second electrical connection terminal 173 is arranged on the bottom wall of the installation frame 171 and located in the second installation cavity 171d, thereby making full use of the space in the height direction of the installation frame 171. Exemplarily, the second electrical connection terminal 173 is arranged on the bottom wall of the installation frame 171 and located in the second installation cavity 171d. When the first AC output assembly 150 is installed in the second installation cavity 171d, the first AC output assembly 150 is electrically connected to the second electrical connection terminal 173. The direction of the second electrical connection terminal 173 relative to the first AC output assembly 150 is opposite to the direction in which the first AC output assembly 150 is placed into the second installation cavity 171d, such that when the first AC output assembly 150 is placed into the second installation cavity 171d, it can quickly plug and connect with the second electrical connection terminal 173, thereby facilitating assembly.

That is, one of the first DC output assembly 130 and the first AC output assembly 150 is electrically connected to the power module 110 through the first electrical connection terminal 172, and the other of the first DC output assembly 130 and the first AC output assembly 150 is electrically connected to the power module 110 through the second electrical connection terminal 173.

As shown in FIG. 15, in some embodiments, the structure of the first electrical connection terminal 172 is the same as the structure of the second electrical connection terminal 173. The first electrical connection terminal 172 can cooperate with either the first DC output assembly 130 or the first AC output assembly 150, and the second electrical connection terminal 173 can cooperate with either the first DC output assembly 130 or the first AC output assembly 150. That is, the installation positions of the first DC output assembly 130 and the first AC output assembly 150 can be swapped, or the first AC output assembly 150 can be replaced with the second DC output assembly 140, or the first DC output assembly 130 can be replaced with the second AC output assembly 180.

As shown in FIGS. 8 and 9, in some embodiments, the first DC output assembly 130 further includes a first housing 132 and a first locking mechanism 133. The first DC voltage conversion module 131 is arranged inside the first housing 132. The first housing 132 can protect the first DC voltage conversion module 131, preventing external damage or interference. The contour shape of the first housing 132 may generally be cubic, making it relatively regular and with high space utilization. Exemplarily, the material of the first housing 132 is plastic, which is lightweight, low-cost, easy to process, can be injection molded into various complex shapes, and provides insulation. Exemplarily, the material of the first housing 132 is metal, providing good heat dissipation performance, assisting the heat dissipation of the first DC voltage conversion module 131, and offering high strength and good load-bearing performance. Exemplarily, the first housing 132 defines multiple heat dissipation holes, which is beneficial for dissipating heat from the first DC voltage conversion module 131.

As shown in FIGS. 8 and 9, the first locking mechanism 133 is arranged on the first housing 132. The first locking mechanism 133 can engage with the accommodating groove 211a to limit and lock the first housing 132 relative to the accommodating groove 211a, that is, to lock the first DC output assembly 130 relative to the accommodating groove 211a. Exemplarily, a first limiting hole is defined on a wall of the accommodating groove 211a, and the first locking mechanism 133 can engage with the first limiting hole through plugging and limiting. Alternatively, a first buckle is arranged on the wall of the accommodating groove 211a, and the first locking mechanism 133 can engage with the first buckle by snapping.

In some embodiments, the first locking mechanism 133 can engage with the installation frame 171 to limit and fix the first housing 132 relative to the installation frame 171, that is, to lock the first DC output assembly 130 relative to the installation frame 171. Exemplarily, a first limiting hole is defined on the installation frame 171, and the first locking mechanism 133 can engage with the first limiting hole through plugging and limiting. Alternatively, a first buckle is arranged on the installation frame 171, and the first locking mechanism 133 can engage with the first buckle by snapping. It should be noted that when the installation frame 171 is arranged in the accommodating groove 211a, the installation frame 171 is fixed relative to the accommodating groove 211a. Locking or releasing the first housing 132 relative to the installation frame 171 may be considered as locking or releasing the first housing 132 relative to the accommodating groove 211a.

As shown in FIGS. 8 and 9, in some embodiments, the first locking mechanism 133 is arranged corresponding to a side wall of the installation frame 171. Generally, the opening 171b of the installation frame 171 faces upward, making it convenient for users to use the first DC output assembly 130 on the tabletop 211. Therefore, the first DC output assembly 130 is usually placed vertically into the installation frame 171. The first locking mechanism 133 is arranged corresponding to the side wall of the installation frame 171, which may facilitate the first locking mechanism 133 to engage with the side wall of the installation frame 171 for limiting and locking, thereby preventing the first DC output assembly 130 from moving vertically.

As shown in FIG. 8, in some embodiments, the first DC output assembly 130 further includes a first handle 134. The first handle 134 is rotatably arranged on the first housing 132, allowing the first DC output assembly 130 to be lifted, thereby facilitating installation and movement.

Exemplarily, as shown in FIG. 9, the first handle 134 is connected to the first locking mechanism 133. When the first handle 134 is rotated to stand up relative to the first housing 132, the first housing 132 is released relative to the accommodating groove 211a. The user can directly lift the first DC output assembly 130 without needing an additional unlocking operation. When the first handle 134 is rotated to fit against the first housing 132, the first housing 132 is locked relative to the accommodating groove 211a without needing an additional locking operation, making it more convenient to use.

As shown in FIG. 8, in some embodiments, the first handle 134 is rotatably arranged on a top of a side wall of the first housing 132. The first handle 134 is relatively far from the center of gravity of the first DC output assembly 130, providing relatively good stability when moving the first DC output assembly 130, thereby reducing the risk of accidental dropping.

As shown in FIG. 8, in some embodiments, when the first handle 134 fits against the first housing 132, a first avoidance space 130a is defined between the first handle 134 and the first housing 132 for rotating the first handle 134. This allows the user to extend their hand into the first avoidance space 130a to rotate the first handle 134, causing it to stand up relative to the first housing 132 for holding the first handle 134.

As shown in FIG. 8, in some embodiments, the first handle 134 can fit against the top of the first housing 132. When the first handle 134 fits against the first housing 132, the first handle 134 is flush with a top wall of the first housing 132, making the top of the first DC output assembly 130 relatively flat, the occupied space more regular, and allowing other items to be placed relatively stably on top of the first DC output assembly 130.

As shown in FIG. 9, in some embodiments, the first locking mechanism 133 includes a first rotating shaft 1331, a first lock tongue 1332, and a first transmission member 1333.

The first rotating shaft 1331 is rotatably arranged inside the first housing 132. A peripheral wall of the first rotating shaft 1331 is arranged with first external threads. The first transmission member 1333 has a first threaded hole. The wall of the first threaded hole is arranged with first internal threads. The first rotating shaft 1331 is rotatably arranged inside the first threaded hole, and the first external threads cooperate with the first internal threads. The first lock tongue 1332 is slidably arranged on the first housing 132 along the axial direction of the first rotating shaft 1331. When the first rotating shaft 1331 rotates, the first transmission member 1333 can drive the first lock tongue 1332 to move. The first lock tongue 1332 is configured to lock with the accommodating groove 211a.

A rotating part of the first handle 134 extends into the first housing 132 and is connected to the first rotating shaft 1331. When the first handle 134 is rotated to stand up relative to the first housing 132, the first lock tongue 1332 retracts into the first housing 132 and is released from the accommodating groove 211a. When the first handle 134 is rotated to fit against the first housing 132, the first lock tongue 1332 extends out of the first housing 132 and locks with the accommodating groove 211a.

As shown in FIG. 9, in some embodiments, the first locking mechanism 133 further includes a first elastic member 1334. Two ends of the first elastic member 1334 abut against the first lock tongue 1332 and the first housing 132 respectively. When the first handle 134 is rotated to fit against the first housing 132, the first elastic member 1334 applies an elastic force to the first lock tongue 1332, causing the first lock tongue 1332 to extend out of the first housing 132 and remain locked with the accommodating groove 211a, thereby reducing the risk of failure of the first locking mechanism 133. When the first handle 134 is rotated to stand up relative to the first housing 132, the first transmission member 1333 can overcome the elastic force of the first elastic member 1334 to drive the first lock tongue 1332 to retract into the first housing 132 and be released from the accommodating groove 211a.

As shown in FIGS. 10 and 11, in some embodiments, the first AC output assembly 150 further includes a second housing 152 and a second locking mechanism 153. The first inverter module 151 is arranged inside the second housing 152. The second housing 152 can protect the first inverter module 151, preventing external damage or interference. The contour shape of the second housing 152 may generally be cubic, making it relatively regular and with high space utilization. Exemplarily, the material of the second housing 152 is plastic, which is lightweight, low-cost, easy to process, can be injection molded into various complex shapes, and provides insulation. Exemplarily, the material of the second housing 152 is metal, providing good heat dissipation performance, assisting the heat dissipation of the first inverter module 151, and offering high strength and good load-bearing performance. Exemplarily, the second housing 152 defines multiple heat dissipation holes, which is beneficial for dissipating heat from the first inverter module 151.

As shown in FIGS. 10 and 11, the second locking mechanism 153 is arranged on the second housing 152. The second locking mechanism 153 can engage with the accommodating groove 211a to limit and lock the second housing 152 relative to the accommodating groove 211a, that is, to lock the first AC output assembly 150 relative to the accommodating groove 211a. Exemplarily, a second limiting hole is defined on a wall of the accommodating groove 211a, and the first locking mechanism 133 can engage with the second limiting hole through plugging and limiting. Alternatively, a second buckle is arranged on the wall of the accommodating groove 211a, and the first locking mechanism 133 can engage with the second buckle by snapping.

In some embodiments, the second locking mechanism 153 can engage with the installation frame 171 to limit and fix the second housing 152 relative to the installation frame 171, that is, to lock the first AC output assembly 150 relative to the accommodating groove 211a. Exemplarily, a second limiting hole is defined on the installation frame 171, and the first locking mechanism 133 can engage with the second limiting hole through plugging and limiting. Alternatively, a second buckle is arranged on the installation frame 171, and the first locking mechanism 133 can engage with the second buckle by snapping. It should be noted that when the installation frame 171 is arranged in the accommodating groove 211a, the installation frame 171 is fixed relative to the accommodating groove 211a. Locking or releasing the second housing 152 relative to the installation frame 171 may be considered as locking or releasing the second housing 152 relative to the accommodating groove 211a.

As shown in FIGS. 10 and 11, in some embodiments, the second locking mechanism 153 is arranged corresponding to a side wall of the installation frame 171. Generally, the opening 171b of the installation frame 171 is arranged facing upward, making it convenient for users to use the first AC output assembly 150 on the tabletop 211. Therefore, the first AC output assembly 150 is usually placed vertically into the installation frame 171. The second locking mechanism 153 is arranged corresponding to the side wall of the installation frame 171, which may facilitate the second locking mechanism 153 to engage with the side wall of the installation frame 171 for limiting and locking, thereby preventing the first AC output assembly 150 from moving vertically.

As shown in FIG. 10, in some embodiments, the first AC output assembly 150 further includes a second handle 154. The second handle 154 is rotatably arranged on the second housing 152, allowing the first AC output assembly 150 to be lifted, facilitating installation and movement.

Exemplarily, as shown in FIG. 11, the second handle 154 is connected to the second locking mechanism 153. When the second handle 154 is rotated to stand up relative to the second housing 152, the second housing 152 is released relative to the accommodating groove 211a. The user can directly lift the first AC output assembly 150 without needing an additional unlocking operation. When the second handle 154 is rotated to fit against the first housing 132, the second housing 152 is locked relative to the accommodating groove 211a without needing an additional locking operation, making it more convenient to use.

As shown in FIG. 10, in some embodiments, the second handle 154 is rotatably arranged on a top of a side wall of the second housing 152. The second handle 154 is relatively far from the center of gravity of the first AC output assembly 150, providing relatively good stability when moving the first AC output assembly 150, thereby reducing the risk of accidental dropping.

As shown in FIG. 10, when the second handle 154 fits against the second housing 152, a second avoidance space 150a is defined between the second handle 154 and the second housing 152 for rotating the second handle 154. This allows the user to extend their hand into the second avoidance space 150a to rotate the second handle 154, causing it to stand up relative to the first housing 132 for holding the second handle 154.

As shown in FIG. 10, the second handle 154 can fit against a top wall of the second housing 152. When the second handle 154 fits against the second housing 152, the second handle 154 is flush with the top wall of the second housing 152, making the top of the first AC output assembly 150 relatively flat, the occupied space more regular, and allowing other items to be placed relatively stably on top of the first AC output assembly 150.

As shown in FIG. 11, in some embodiments, the second locking mechanism 153 includes a second rotating shaft 1531, a second lock tongue 1532, and a second transmission member 1533.

The second rotating shaft 1531 is rotatably arranged inside the second housing 152. A peripheral wall of the second rotating shaft 1531 is arranged with second external threads. The second transmission member 1533 has a second threaded hole. The wall of the second threaded hole is arranged with second internal threads. The second rotating shaft 1531 is rotatably arranged inside the second threaded hole, and the second external threads cooperate with the second internal threads. The second lock tongue 1532 is slidably arranged on the second housing 152 along the axial direction of the second rotating shaft 1531. When the second rotating shaft 1531 rotates, the second transmission member 1533 can drive the second lock tongue 1532 to move. The second lock tongue 1532 is configured to lock with the accommodating groove 211a.

A rotating part of the second handle 154 extends into the second housing 152 and is connected to the second rotating shaft 1531. When the second handle 154 is rotated to stand up relative to the second housing 152, the second lock tongue 1532 retracts into the second housing 152 and is released from the accommodating groove 211a. When the second handle 154 is rotated to fit against the second housing 152, the second lock tongue 1532 extends out of the second housing 152 and locks with the accommodating groove 211a.

As shown in FIG. 11, in some embodiments, the second locking mechanism 153 further includes a second elastic member 1534. Two ends of the second elastic member 1534 abut against the second lock tongue 1532 and the second housing 152 respectively. When the second handle 154 is rotated to fit against the second housing 152, the second elastic member 1534 applies an elastic force to the second lock tongue 1532, causing the second lock tongue 1532 to extend out of the second housing 152 and remain locked with the accommodating groove 211a, thereby reducing the risk of failure of the second locking mechanism 153. When the second handle 154 is rotated to stand up relative to the second housing 152, the second transmission member 1533 can overcome the elastic force of the second elastic member 1534 to drive the second lock tongue 1532 to retract into the second housing 152 and be released from the accommodating groove 211a.

As shown in FIG. 17, in some embodiments, the integrated power supply system 100 further includes a retractable cable assembly 160. The retractable cable assembly 160 is electrically and detachably connected to the first DC output assembly 130. When the user needs to use the retractable cable assembly 160, the retractable cable assembly 160 can be installed on the first DC output assembly 130. When the user does not need to use the retractable cable assembly 160, the retractable cable assembly 160 can be detached from the first DC output assembly 130. The detachable electrical connection between the retractable cable assembly 160 and the first DC output assembly 130 may be, for example, terminal plugging/unplugging or magnetic contact connection, making installation and disassembly relatively simple and convenient. Exemplarily, the retractable cable assembly 160 and the first DC output assembly 130 are plug-connected via a USB Type-C interface, achieving a detachable electrical connection.

The retractable cable assembly 160 includes at least one data cable 161 and a retractable structure 165 supporting the at least one data cable 161 to be retractable. When the retractable cable assembly 160 is electrically connected to the first DC output assembly 130, the at least one data cable 161 is electrically connected to the first DC voltage conversion module 131. The first DC voltage conversion module 131 can supply power to the data cable 161 of the retractable cable assembly 160. The user can use the data cable 161 to charge electronic products such as mobile phones. The data cable 161 includes at least one DC output port arranged outside the retractable cable assembly 160. The type of the DC output port may exemplarily be USB Type-C, Lighting, Micro USB, etc.

In some embodiments, the first power supply assembly 121 includes at least one of the retractable cable assembly 160 and the first DC output assembly 130, and both the retractable cable assembly 160 and the first DC output assembly 130 have DC output interfaces. The retractable cable assembly 160 can be directly electrically connected to the power module 110, and the DC voltage output by the power module 110 is the voltage required by the user, eliminating the need to set up the first DC output assembly 130.

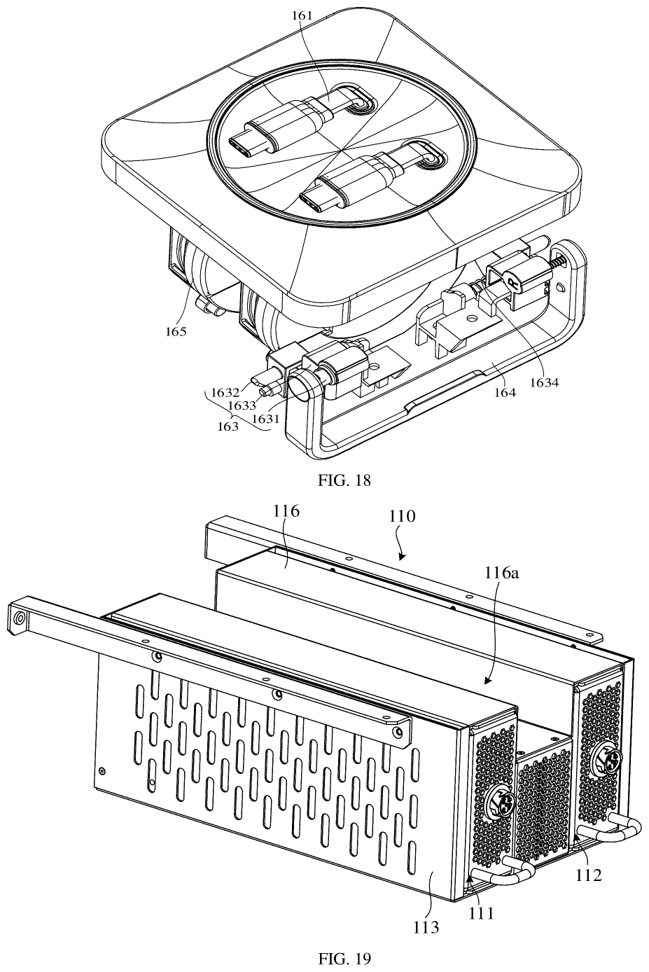

As shown in FIGS. 17 and 18, in some embodiments, the retractable cable assembly 160 includes a third housing 162. The retractable structure 165 may be a cable reel. The cable reel is rotatably arranged inside the third housing 162. The third housing 162 can protect the retractable structure 165 and the data cable 161. The contour shape of the third housing 162 may generally be cubic, making it relatively regular and with high space utilization. Exemplarily, the material of the third housing 162 is plastic, which is lightweight, low-cost, easy to process, can be injection molded into various complex shapes, and provides insulation. Exemplarily, the material of the third housing 162 is metal, providing high strength and good load-bearing performance.

The data cable 161 can be wound around the cable reel, achieving retractability of the data cable 161. Exemplarily, the cable reel is arranged with a conductive slip ring, and the data cable 161 is electrically connected to the first DC voltage conversion module 131 through the conductive slip ring. Exemplarily, the cable reel is arranged with a coil spring to achieve automatic reset of the cable reel, that is, automatic retraction of the data cable 161.

Alternatively, the retractable structure 165 may be a spiral spring, allowing the data cable 161 to be wound around the spiral spring. When the spiral spring extends, the data cable 165 extends; when the spiral spring contracts, the data cable 165 retracts.

In other embodiments, the data cable 161 itself has a spiral spring-like structure, allowing it to be stretched or shortened.

As shown in FIGS. 17 and 18, in some embodiments, the retractable cable assembly 160 further includes a third locking mechanism 163. The third locking mechanism 163 is arranged on the third housing 162. The third locking mechanism 163 can engage with the accommodating groove 211a to limit and lock the third housing 162 relative to the accommodating groove 211a, that is, to lock the retractable cable assembly 160 relative to the accommodating groove 211a. Exemplarily, a third limiting hole is defined on the wall of the accommodating groove 211a, and the third locking mechanism 163 can engage with the third limiting hole through plugging and limiting. Alternatively, a third buckle is arranged on the wall of the accommodating groove 211a, and the third locking mechanism 163 can engage with the third buckle by snapping.

In some embodiments, the third locking mechanism 163 can engage with the installation frame 171 to limit and fix the third housing 162 relative to the installation frame 171, that is, to lock the retractable cable assembly 160 relative to the installation frame 171. Exemplarily, a third limiting hole is defined on the installation frame 171, and the third locking mechanism 163 can engage with the third limiting hole through plugging and limiting. Alternatively, a third buckle is arranged on the installation frame 171, and the third locking mechanism 163 can engage with the third buckle by snapping. It should be noted that when the installation frame 171 is arranged in the accommodating groove 211a, the installation frame 171 is fixed relative to the accommodating groove 211a. Locking or releasing the third housing 162 relative to the installation frame 171 may be considered as locking or releasing the third housing 162 relative to the accommodating groove 211a.

As shown in FIGS. 17 and 18, in some embodiments, the third locking mechanism 163 is arranged corresponding to the side wall 1712 of the installation frame 171. Generally, the opening 171b of the installation frame 171 faces upward, making it convenient for users to use the retractable cable assembly 160 on the tabletop 211. Therefore, the retractable cable assembly 160 is usually placed vertically into the installation frame 171. The third locking mechanism 163 is arranged corresponding to the side wall 1712 of the installation frame 171, which may facilitate the third locking mechanism 163 to engage with the side wall 1712 of the installation frame 171 for limiting and locking, thereby preventing the retractable cable assembly 160 from moving vertically.

As shown in FIG. 17, in some embodiments, the retractable cable assembly 160 further includes a third handle 164. The third handle 164 is rotatably arranged on the third housing 162, allowing the retractable cable assembly 160 to be lifted, thereby facilitating installation and movement.

Exemplarily, as shown in FIG. 18, the third handle 164 is connected to the third locking mechanism 163. When the third handle 164 is rotated to stand up relative to the third housing 162, the third housing 162 is released relative to the accommodating groove 211a. The user can directly lift the retractable cable assembly 160 without needing an additional unlocking operation. When the third handle 164 is rotated to fit against the third housing 162, the third housing 162 is locked relative to the accommodating groove 211a without needing an additional locking operation, making it more convenient to use.

As shown in FIG. 18, in some embodiments, the third locking mechanism 163 includes a third rotating shaft 1631, a third lock tongue 1632, and a third transmission member 1633.

The third rotating shaft 1631 is rotatably arranged inside the third housing 162. A peripheral wall of the third rotating shaft 1631 is arranged with third external threads. The third transmission member 1633 has a third threaded hole. The wall of the third threaded hole is arranged with third internal threads. The third rotating shaft 1631 is rotatably arranged inside the third threaded hole, and the third external threads cooperate with the third internal threads. The third lock tongue 1632 is slidably arranged on the third housing 162 along the axial direction of the third rotating shaft 1631. When the third rotating shaft 1631 rotates, the third transmission member 1633 can drive the third lock tongue 1632 to move. The third lock tongue 1632 is configured to engage with the accommodating groove 211a for limiting.

A rotating part of the third handle 164 extends into the third housing 162 and is connected to the third rotating shaft 1631. When the third handle 164 is rotated to stand up relative to the third housing 162, the third lock tongue 1632 retracts into the third housing 162 and is released from the accommodating groove 211a. When the third handle 164 is rotated to fit against the third housing 162, the third lock tongue 1632 extends out of the third housing 162 and locks with the accommodating groove 211a.

As shown in FIG. 18, in some embodiments, the third locking mechanism 163 further includes a third elastic member 1634. Two ends of the third elastic member 1634 abut against the third lock tongue 1632 and the third housing 162 respectively. When the third handle 164 is rotated to fit against the third housing 162, the third elastic member 1634 applies an elastic force to the third lock tongue 1632, causing the third lock tongue 1632 to extend out of the third housing 162 and remain locked with the accommodating groove 211a, thereby reducing the risk of failure of the third locking mechanism 163. When the third handle 164 is rotated to stand up relative to the third housing 162, the third transmission member 1633 can overcome the elastic force of the third elastic member 1634 to drive the third lock tongue 1632 to retract into the third housing 162 and be released from the accommodating groove 211a.

As shown in FIG. 17, in some embodiments, the data cable 161 extends from a top of the third housing 162. The third handle 164 is connected to the middle part of a side wall of the third housing 162. The third handle 164 can be folded and stored against the side wall of the third housing 162, thereby avoiding interference with the data cable 161 at the top.

As shown in FIG. 17, when the third handle 164 fits against the third housing 162, a third avoidance space is defined between the third handle 164 and the third housing 162 for rotating the third handle 164. This allows the user to extend their hand into the third avoidance space to rotate the third handle 164, causing it to stand up relative to the first housing 132 for holding the third handle 164.

As shown in FIG. 17, the third handle 164 can fit against the side wall of the third housing 162. When the third handle 164 fits against the third housing 162, the third handle 164 is flush with the side wall of the third housing 162, making the side wall of the first AC output assembly 150 relatively flat and the occupied space more regular.

As shown in FIG. 19, a fourth aspect of the embodiments of the present disclosure provides a power module 110. The power module 110 includes a first casing 113, a first power supply 111, and a second power supply 112.

The contour shape of the first casing 113 may generally be cubic, making it relatively regular and with high space utilization. Exemplarily, the material of the first casing 113 is plastic, which is lightweight, low-cost, easy to process, can be injection molded into various complex shapes, and provides insulation. Exemplarily, the material of the first casing 113 is metal, providing good heat dissipation performance, assisting the heat dissipation of the first DC voltage conversion module 131, and offering high strength and good load-bearing performance. Exemplarily, the first casing 113 defines multiple heat dissipation holes, which is beneficial for dissipating heat from the first power supply 111 and the second power supply 112.

The first power supply 111 is arranged inside the first casing 113. The first power supply 111 includes a first rectification module 1111. The first rectification module 1111 is configured to receive AC power input and output a first DC voltage. The second power supply 112 is arranged inside the first casing 113. The second power supply 112 is spaced apart from the first power supply 111. The second power supply 112 includes a second rectification module 1121. The second rectification module 1121 is configured to receive AC power input and output a second DC voltage.

By arranging the first power supply 111 and the second power supply 112 inside the first casing 113, the integration level of the power module 110 may be improved, the installation complexity of the power module 110 may be reduced, and wiring may be facilitated.

Exemplarily, the power of the first power supply 111 is less than or equal to 1000 watts, such that a fan may not be necessary, relying only on natural heat dissipation. This reduces the complexity of the power module 110 and makes the power module 110 relatively quiet during operation.

Exemplarily, the power of the second power supply 112 is less than or equal to 1000 watts, such that a fan may not be necessary, relying only on natural heat dissipation. This reduces the complexity of the power module 110 and makes the power module 110 relatively quiet during operation.

In some embodiments, at least two sets of power supply assemblies are provided, and the at least two sets of power supply assemblies share one power module 110.

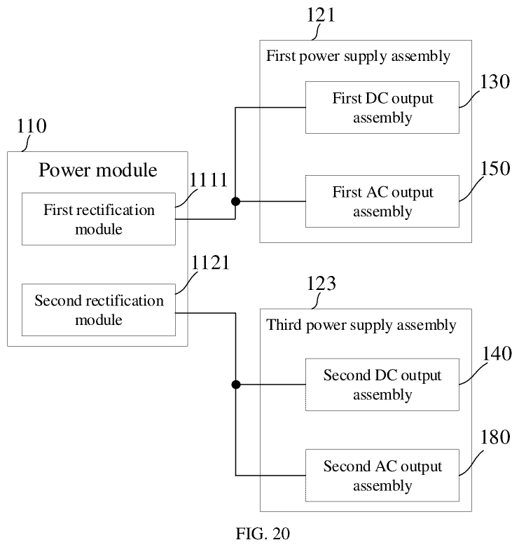

As shown in FIG. 20, in some embodiments, the first power supply 111 and the second power supply 112 supply power to the first power supply assembly 121 and the third power supply assembly 123 respectively. Exemplarily, the first rectification module 1111 is electrically connected to both the first DC output assembly 130 and the first AC output assembly 150. The second rectification module 1121 is electrically connected to both the second DC output assembly 140 and the second AC output assembly 180.

In other embodiments, the first power supply 111 can be simultaneously electrically connected to the first power supply assembly 121 and the second power supply assembly 122, to simultaneously supply power to the first power supply assembly 121 and the second power supply assembly 122, or to supply power to the first power supply assembly 121 alone, or to supply power to the second power supply assembly 122 alone. Exemplarily, the first rectification module 1111 is simultaneously electrically connected to two first DC output assemblies 130 and two first AC output assemblies 150.

In other embodiments, the second power supply 112 can be simultaneously electrically connected to the third power supply assembly 123 and the fourth power supply assembly 124, to simultaneously supply power to the third power supply assembly 123 and the fourth power supply assembly 124, or to supply power to the third power supply assembly 123 alone, or to supply power to the fourth power supply assembly 124 alone. Exemplarily, the second rectification module 1121 is simultaneously electrically connected to two second DC output assemblies 140 and two second AC output assemblies 180.

In some embodiments, the DC voltage output by the first rectification module 1111 is less than or equal to 60V. A DC voltage below 60V is generally considered relatively safe because when the voltage is below 60V, the human body's perception of current is weak, and even contact with the current will not cause serious harm. Exemplarily, the DC voltage output by the first rectification module 1111 may be 60V, 50V, 48V, 36V, 24V, 20V, etc.

In some embodiments, the DC voltage output by the second rectification module 1121 is less than or equal to 60V. A DC voltage below 60V is generally considered relatively safe because when the voltage is below 60V, the human body's perception of current is weak, and even contact with the current will not cause serious harm. Exemplarily, the DC voltage output by the second rectification module 1121 may be 60V, 50V, 48V, 36V, 24V, 20V, etc.

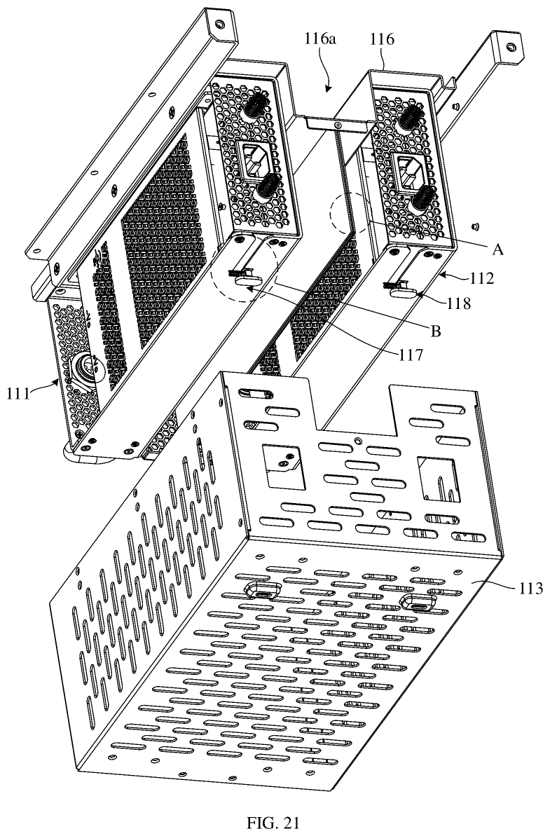

As shown in FIG. 21, in some embodiments, the power module 110 further includes a cover 116. The cover 116 is placed on a top of the first casing 113. A side of the cover 116 facing a bottom wall of the first casing 113 concavely defines a wire routing groove 116a. The wire routing groove 116a is arranged between the first power supply 111 and the second power supply 112. By providing the wire routing groove 116a, the wiring may be made tidier. Moreover, since the wire routing groove 116a can provide a certain isolation effect, it may improve the thermal insulation performance between the first power supply 111 and the second power supply 112.

As shown in FIG. 21, in some embodiments, the first power supply 111 and the second power supply 112 are spaced apart in the horizontal direction. Since hot air is lighter, heat usually dissipates upward. Therefore, spacing the first power supply 111 and the second power supply 112 apart in the horizontal direction may reduce their mutual influence.

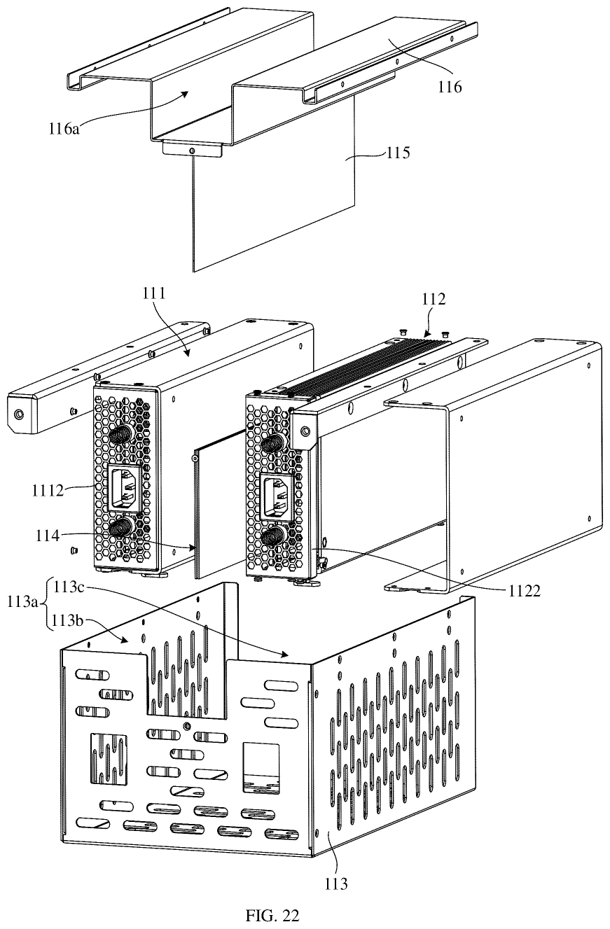

As shown in FIG. 22, in some embodiments, the power module 110 further includes a thermal insulation member 114. The thermal insulation member 114 is arranged between the first power supply 111 and the second power supply 112. By providing the thermal insulation member 114, heat conduction between the first power supply 111 and the second power supply 112 may be reduced, thereby minimizing their mutual influence. When the first power supply 111 overheats, the thermal insulation member 114 can provide a certain thermal insulation effect, such that the impact on the second power supply 112 is relatively small, and the second power supply 112 can maintain normal operation. Similarly, when the second power supply 112 overheats, the thermal insulation member 114 can provide a certain thermal insulation effect, such that the impact on the first power supply 111 is relatively small, and the first power supply 111 can maintain normal operation.

As shown in FIG. 22, in some embodiments, the first casing 113 includes an accommodating cavity 113a. The power module 110 further includes a partition member 115. The partition member 115 divides the accommodating cavity 113a into a first accommodating cavity 113b and a second accommodating cavity 113c. The first power supply 111 is arranged in the first accommodating cavity 113b, and the second power supply 112 is arranged in the second accommodating cavity 113c. It should be noted that the first accommodating cavity 113b and the second accommodating cavity 113c may or may not be communicated with each other, as long as there is a certain barrier between them. By arranging the first power supply 111 and the second power supply 112 in different cavities, the heat conduction effect between the two power supplies may be relatively poor, thereby minimizing their mutual influence.

In some embodiments, the partition member 115 is connected to the bottom wall and the two opposite side walls of the first casing 113 to divide the accommodating cavity 113a into the first accommodating cavity 113b and the second accommodating cavity 113c, which are not communicated with each other, thereby improving the thermal insulation effect between the first power supply 111 and the second power supply 112.

As shown in FIG. 22, in some embodiments, the partition member 115 is arranged between the first power supply 111 and the second power supply 112. The thermal insulation member 114 is arranged on the partition member 115. The partition member 115 can further support the thermal insulation member 114. Exemplarily, the partition member 115 is plate-shaped, and the thermal insulation member 114 is arranged on both sides of the partition member 115.

As shown in FIG. 22, in some embodiments, the first power supply 111 includes a second casing 1112. The first rectification module 1111 is arranged inside the second casing 1112. The contour shape of the second casing 1112 may generally be cubic, making it relatively regular and with high space utilization. Exemplarily, the material of the second casing 1112 is plastic, which is lightweight, low-cost, easy to process, can be injection molded into various complex shapes, and provides insulation. Exemplarily, the material of the second casing 1112 is metal, providing good heat dissipation performance, assisting the heat dissipation of the first DC voltage conversion module 131, and offering high strength and good load-bearing performance. Exemplarily, the second casing 1112 defines multiple heat dissipation holes, which is beneficial for dissipating heat from the first power supply 111.

The thickness direction of the second casing 1112 is arranged parallel to the horizontal plane. It is understandable that the two surfaces perpendicular to the thickness direction of the second casing 1112 are usually the largest surfaces of the second casing 1112. Arranged this way, the two largest surfaces of the second casing 1112 are located on the sides, which is beneficial for heat dissipation of the first power supply 111.

As shown in FIG. 22, in some embodiments, the second power supply 112 includes a third casing 1122. The second rectification module 1121 is arranged inside the third casing 1122. The contour shape of the third casing 1122 may generally be cubic, making it relatively regular and with high space utilization. Exemplarily, the material of the third casing 1122 is plastic, which is lightweight, low-cost, easy to process, can be injection molded into various complex shapes, and provides insulation. Exemplarily, the material of the third casing 1122 is metal, providing good heat dissipation performance, assisting the heat dissipation of the first DC voltage conversion module 131, and offering high strength and good load-bearing performance. Exemplarily, the third casing 1122 defines multiple heat dissipation holes, which is beneficial for dissipating heat from the second power supply 112.

The thickness direction of the third casing 1122 is arranged parallel to the horizontal plane. It is understandable that the two surfaces perpendicular to the thickness direction of the third casing 1122 are usually the largest surfaces of the third casing 1122. Arranged this way, the two largest surfaces of the third casing 1122 are located on the sides, which is beneficial for heat dissipation of the second power supply 112.

As shown in FIGS. 21 and 22, in some embodiments, the power module 110 further includes a first quick-release mechanism 117. The first quick-release mechanism 117 is arranged on the first casing 113 or the second casing 1112. The first quick-release mechanism 117 can lock or release with the second casing 1112, allowing the second casing 1112 to be fixed or movable relative to the first casing 113, thereby facilitating the installation of the first power supply 111 inside the first casing 113 and the removal of the first power supply 111 from the first casing 113. Exemplarily, a fourth limiting hole is defined on a wall of the second casing 1112, and the first quick-release mechanism 117 can engage with the fourth limiting hole through plugging and limiting. Alternatively, a fourth buckle is arranged on the wall of the second casing 1112, and the first quick-release mechanism 117 can engage with the fourth buckle by snapping.

As shown in FIGS. 21 and 22, in some embodiments, the power module 110 further includes a second quick-release mechanism 118. The second quick-release mechanism 118 is arranged on the first casing 113 or the third casing 1122. The second quick-release mechanism 118 can lock or release with the third casing 1122, allowing the third casing 1122 to be fixed or movable relative to the first casing 113, thereby facilitating the installation of the second power supply 112 inside the first casing 113 and the removal of the second power supply 112 from the first casing 113. Exemplarily, a fifth limiting hole is defined on a wall of the third casing 1122, and the second quick-release mechanism 118 can engage with the fifth limiting hole through plugging and limiting. Alternatively, a fifth buckle is arranged on the wall of the third casing 1122, and the second quick-release mechanism 118 can engage with the fifth buckle by snapping.

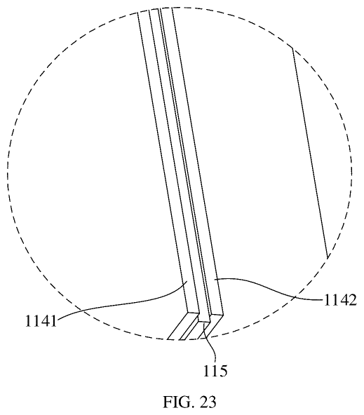

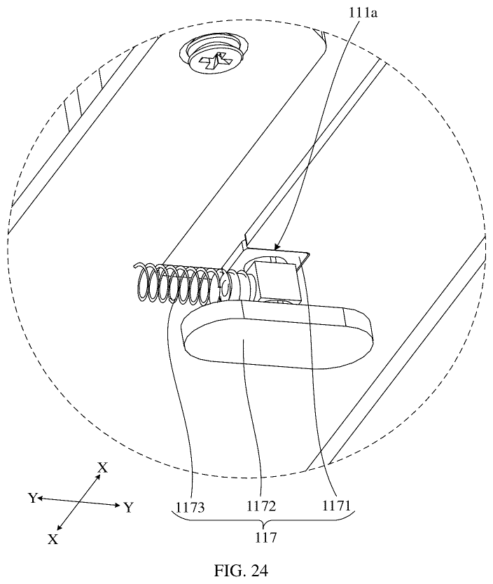

As shown in FIG. 23, in some embodiments, the thermal insulation member 114 includes a first thermal insulation film 1141 and a second thermal insulation film 1142. The partition member 115 has a first surface facing the first power supply 111 and a second surface facing the second power supply 112. The first thermal insulation film 1141 is arranged on the first surface, and the second thermal insulation film 1142 is arranged on the second surface. By arranging thermal insulation films on both surfaces of the partition member 115, both sides of the partition member 115 may have relatively good thermal insulation performance, thereby improving the thermal insulation effect.

In some embodiments, the first thermal insulation film 1141 is spaced apart from the first power supply 111. There is air between the first thermal insulation film 1141 and the first power supply 111. Air is a poor conductor of heat, such that it may improve the thermal insulation effect between the first thermal insulation film 1141 and the first power supply 111.

In some embodiments, the second thermal insulation film 1142 is spaced apart from the second power supply 112. There is air between the second thermal insulation film 1142 and the second power supply 112. Air is a poor conductor of heat, such that it may improve the thermal insulation effect between the second thermal insulation film 1142 and the second power supply 112.

In some embodiments, the first thermal insulation film 1141 covers the first surface, meaning there are no exposed areas on the first surface of the thermal insulation member 114, thereby maximizing the thermal insulation effect of the first surface.

In some embodiments, the second thermal insulation film 1142 covers the second surface, meaning there are no exposed areas on the second surface of the thermal insulation member 114, thereby maximizing the thermal insulation effect of the second surface.

As shown in FIG. 24, in some embodiments, the second casing 1112 is slidably arranged in the first casing 113 along a first direction XX. The second casing 1112 defines a first limiting groove 111a. The first quick-release mechanism 117 includes a first limiting member 1171 and a first button 1172 connected to the first limiting member 1171. The first limiting member 1171 is slidably arranged on the first casing 113 along a second direction YY. The second direction YY is set at an angle to the first direction XX. When the first limiting member 1171 slides into the first limiting groove 111a, the second casing 1112 is fixed relative to the third casing 1122. When the first limiting member 1171 exits the first limiting groove 111a, the second casing 1112 is movable relative to the third casing 1122.

Exemplarily, the first quick-release mechanism 117 further includes a fourth elastic member 1173. Two ends of the fourth elastic member 1173 abut against the first limiting member 1171 and the first casing 113 respectively. The fourth elastic member 1173 applies an elastic force to the first limiting member 1171 to press it into the first limiting groove 111a and keep it fixed with the first limiting groove 111a, thereby reducing the risk of failure of the first quick-release mechanism 117. When the user presses the first button 1172, by overcoming the elastic force of the fourth elastic member 1173, the first limiting member 1171 is driven out of the first limiting groove 111a, thereby allowing the first power supply 111 to be moved.

In some embodiments, the third casing 1122 is slidably arranged in the first casing 113 along the first direction XX. The third casing 1122 defines a second limiting groove. The second quick-release mechanism 118 includes a second limiting member and a second button connected to the second limiting member. The second limiting member is slidably arranged on the first casing 113 along the second direction YY. The second direction YY is set at an angle to the first direction XX. When the second limiting member slides into the second limiting groove, the third casing 1122 is fixed relative to the first casing 113. When the second limiting member exits the second limiting groove, the third casing 1122 is movable relative to the first casing 113. The structure of the second quick-release mechanism 118 may refer to the first quick-release mechanism 117.

Exemplarily, the second quick-release mechanism 118 further includes a fifth elastic member. Two ends of the fifth elastic member abut against the second limiting member and the first casing 113 respectively. The fifth elastic member applies an elastic force to the second limiting member to press it into the second limiting groove and keep it fixed with the second limiting groove, thereby reducing the risk of failure of the second quick-release mechanism 118. When the user presses the second button, by overcoming the elastic force of the fifth elastic member, the second limiting member is driven out of the second limiting groove, thereby allowing the second power supply 112 to be moved.

The above descriptions are merely some embodiments of the present disclosure and do not limit the scope of the present disclosure. Any equivalent structural transformation made based on the concepts of the present disclosure and the contents of the description and drawings of the present disclosure, or direct/indirect application in other related technical fields, shall be included within the scope of the present disclosure.

What is claimed is:

1. An integrated power supply system, comprising:
a power module;
at least one first direct current (DC) output assembly, electrically connected to the power module;
wherein the first DC output assembly comprises at least one DC output interface, the DC output interface being configured to provide direct current to a load connected to the first DC output assembly; and
at least one first alternating current (AC) output assembly, electrically connected to the power module; wherein the first AC output assembly comprises at least one AC output interface, the AC output interface being configured to provide alternating current to another load connected to the first AC output assembly.

2. The integrated power supply system according to claim 1, wherein the power module comprises a first power supply, the first power supply comprises a first rectification module, and the first rectification module is configured to receive an alternating current input and output a direct current;
the first DC output assembly comprises a first DC voltage conversion module electrically connected to the first rectification module, and the at least one DC output interface is electrically connected to the first DC voltage conversion module; the first DC voltage conversion module is configured to receive the direct current output from the first rectification module and provide the direct current via the at least one DC output interface to the load connected to the first DC output assembly;
the first AC output assembly comprises a first inverter module electrically connected to the first rectification module, and the at least one AC output interface is electrically connected to the first inverter module; the first inverter module is configured to receive the direct current output from the first rectification module and provide the alternating current via the at least one AC output interface to the load connected to the first AC output assembly.

3. The integrated power supply system according to claim 1, wherein the integrated power supply system further comprises a retractable cable assembly; the retractable cable assembly comprises at least one data cable and a retractable structure supporting retractability of the at least one data cable; the retractable cable assembly is electrically connected to the first DC output assembly or the power module; each of the at least one data cable comprises at least one DC output port disposed outside the retractable cable assembly.

4. The integrated power supply system according to claim 3, wherein the retractable cable assembly is detachably electrically connected to the first DC output assembly; the retractable cable assembly is disposed above the first DC output assembly.

5. The integrated power supply system according to claim 4, wherein the retractable cable assembly blocks a partial area of a top of the first DC output assembly, and the top of the first DC output assembly is arranged with the at least one DC output interface exposed from the retractable cable assembly.

6. The integrated power supply system according to claim 4, wherein the first DC output assembly and the first AC output assembly are arranged side by side, and the integrated power supply system further comprises a brush cover plate; the brush cover plate is arranged side by side with a top end of the retractable cable assembly, and the brush cover plate is spaced apart from the first AC output assembly.

7. The integrated power supply system according to claim 3, wherein the integrated power supply system further comprises an installation frame, and the first DC output assembly, the first AC output assembly, and the retractable cable assembly are all disposed within the installation frame; at least one of the first DC output assembly, the first AC output assembly, and the retractable cable assembly is detachably connected to the installation frame.

8. The integrated power supply system according to claim 7, wherein at least one of the following is satisfied:
in a case 1: the first DC output assembly further comprises a first housing and a first locking mechanism disposed on the first housing; the first locking mechanism is capable of engaging with the installation frame to lock the first housing relative to the installation frame;
in a case 2: the first AC output assembly further comprises a second housing and a second locking mechanism disposed on the second housing; the second locking mechanism is capable of engaging with the installation frame to lock the second housing relative to the installation frame; and
in a case 3: the retractable cable assembly further comprises a third housing and a third locking mechanism disposed on the third housing; the third locking mechanism is capable of engaging with the installation frame to lock the third housing relative to the installation frame.

9. The integrated power supply system according to claim 8, wherein,
in the case 1, the first DC output assembly further comprises a first handle rotatably disposed on the first housing and operatively connected to the first locking mechanism; wherein, in a case where the first handle is rotated to an upright position relative to the first housing, the first housing is unlocked relative to the installation frame; in a case where the first handle is rotated to a flush position relative to the first housing, the first housing is locked relative to the installation frame;
in the case 2, the first AC output assembly further comprises a second handle rotatably disposed on the second housing and operatively connected to the second locking mechanism; wherein, in a case where the second handle is rotated to an upright position relative to the second housing, the second housing is unlocked relative to the installation frame; in a case where the second handle is rotated to a flush position relative to the second housing, the second housing is locked relative to the installation frame;
in the case 3, the retractable cable assembly further comprises a third handle rotatably disposed on the third housing and operatively connected to the third locking mechanism; wherein, in a case where the third handle is rotated to an upright position relative to the third housing, the third housing is unlocked relative to the installation frame; in a case where the third handle is rotated to a flush position relative to the third housing, the third housing is locked relative to the installation frame.

10. The integrated power supply system according to claim 9, wherein,
in the case 1, the first locking mechanism comprises:
a first rotating shaft, rotatably disposed in the first housing; wherein a peripheral wall of the first rotating shaft is arranged with a first external thread, and a rotating portion of the first handle extends into the first housing and is connected to the first rotating shaft;
a first lock tongue, slidably disposed in the first housing along an axial direction of the first rotating shaft; wherein the first lock tongue is configured to lock with the installation frame; and
a first transmission member, having a first threaded hole; wherein an inner wall of the first threaded hole is arranged with a first internal thread; the first rotating shaft is rotatably disposed within the first threaded hole, and the first external thread is threadedly engaged with the first internal thread; the first transmission member is capable of driving the first lock tongue to move in a case where the first rotating shaft rotates;
wherein, in a case where the first handle is rotated to the upright position relative to the first housing, the first lock tongue retracts into the first housing and is unlocked from the installation frame; in a case where the first handle is rotated to the flush position relative to the first housing, the first lock tongue extends out of the first housing and locks with the installation frame;
in the case 2, the second locking mechanism comprises:
a second rotating shaft rotatably, disposed in the second housing; wherein a peripheral wall of the second rotating shaft is arranged with a second external thread, and a rotating portion of the second handle extends into the second housing and is connected to the second rotating shaft;
a second lock tongue slidably, disposed in the second housing along an axial direction of the second rotating shaft; wherein the second lock tongue is configured to lock with the installation frame; and
a second transmission member, having a second threaded hole; wherein an inner wall of the second threaded hole is arranged with a second internal thread; the second rotating shaft is rotatably disposed within the second threaded hole, and the second external thread is threadedly engaged with the second internal thread; the second transmission member is capable of driving the second lock tongue to move in a case where the second rotating shaft rotates;
wherein, in a case where the second handle is rotated to the upright position relative to the second housing, the second lock tongue retracts into the second housing and is unlocked from the installation frame; in a case where the second handle is rotated to the flush position relative to the second housing, the second lock tongue extends out of the second housing and locks with the installation frame;
in the case 3, the third locking mechanism comprises:
a third rotating shaft, rotatably disposed in the third housing; wherein a peripheral wall of the third rotating shaft is arranged with a third external thread, and a rotating portion of the third handle extends into the third housing and is connected to the third rotating shaft;
a third lock tongue, slidably disposed in the third housing along an axial direction of the third rotating shaft; wherein the third lock tongue is configured to lock with the installation frame; and
a third transmission member, having a third threaded hole; wherein an inner wall of the third threaded hole is arranged with a third internal thread; the third rotating shaft is rotatably disposed within the third threaded hole, and the third external thread is threadedly engaged with the third internal thread; the third transmission member is capable of driving the third lock tongue to move in a case where the third rotating shaft rotates;
wherein, in a case where the third handle is rotated to the upright position relative to the third housing, the third lock tongue retracts into the third housing and is unlocked from the installation frame; in a case where the third handle is rotated to the flush position relative to the third housing, the third lock tongue extends out of the third housing and locks with the installation frame.

11. The integrated power supply system according to claim 7, wherein the integrated power supply system further comprises a first electrical connection terminal and a second electrical connection terminal, and the first electrical connection terminal and the second electrical connection terminal are both disposed on the installation frame;
one of the first DC output assembly and the first AC output assembly is electrically connected to the power module via the first electrical connection terminal, and the other of the first DC output assembly and the first AC output assembly is electrically connected to the power module via the second electrical connection terminal;
at least one of the first electrical connection terminal and the second electrical connection terminal is disposed on a bottom of the installation frame.

12. The integrated power supply system according to claim 7, wherein a partition plate is disposed inside the installation frame; the installation frame has a first installation cavity and a second installation cavity separated by the partition plate, and the first DC output assembly and the first AC output assembly are respectively arranged in the first installation cavity and the second installation cavity.

13. The integrated power supply system according to claim 2, wherein the power module further comprises:
a first casing, the first casing having an accommodating cavity; wherein the first power supply is disposed in the accommodating cavity of the first casing, and the first rectification module is configured to receive the alternating current input and output a first direct current voltage;
a second power supply, disposed in the accommodating cavity of the first casing and spaced apart from the first power supply; wherein the second power supply comprises a second rectification module, and the second rectification module is configured to receive the alternating current input and output a second direct current voltage; and
a thermal insulation member, disposed between the first power supply and the second power supply.

14. The integrated power supply system according to claim 13, wherein the first power supply comprises a second casing, and the first rectification module is disposed in the second casing; the power module further comprises a first release mechanism, and the first release mechanism is disposed on the first casing or the second casing; the first release mechanism is configured to lock or release the second casing to fix or allow movement of the second casing relative to the first casing;
the second power supply comprises a third casing, and the second rectification module is disposed in the third casing; the power module further comprises a second release mechanism, and the second release mechanism is disposed on the first casing or the third casing; the second release mechanism is configured to lock or release the third casing to fix or allow movement of the third casing relative to the first casing.

15. An integrated power supply system, comprising:
a power module; and
at least one power supply assembly, electrically connected to the power module; wherein each power supply assembly comprises at least one direct current (DC) output interface and at least one alternating current (AC) output interface; each DC output interface is configured to provide direct current to a load connected to the power supply assembly, and each AC output interface is configured to provide alternating current to another load connected to the power supply assembly.

16. The integrated power supply system according to claim 15, wherein the power supply assembly comprises a retractable cable assembly and a DC output assembly; the at least one DC output interface is a plurality of DC output interfaces that are arranged on the retractable cable assembly and the DC output assembly.

17. The integrated power supply system according to claim 15, wherein the at least one power supply assembly is at least two power supply assemblies, and the at least two power supply assemblies share the power module;
the at least two power supply assemblies are arranged side by side along a first direction; and/or, the at least two power supply assemblies are spaced apart along a second direction, wherein the first direction is perpendicular to the second direction.

18. An integrated power supply table, comprising:
a table body;
a power module; and
at least one power supply assembly, electrically connected to the power module; wherein each power supply assembly comprises at least one direct current (DC) output interface and at least one alternating current (AC) output interface; each DC output interface is configured to provide direct current to a load connected to the power supply assembly, and each AC output interface is configured to provide alternating current to another load connected to the power supply assembly.

19. The integrated power supply table according to claim 18, wherein the at least one power supply assembly is at least two power supply assemblies, and the at least two power supply assemblies share the power module.

20. The integrated power supply table according to claim 18, wherein a part of the power supply assembly is arranged in an area below a tabletop of the table body, and the at least one DC output interface or the at least one AC output interface is exposed on the tabletop.
